(19) United States
(12) Patent Application Publication
(10) Pub. No.: US 2024/0406970 A1
(43) Pub. Date: Dec. 5, 2024

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Yi ZHANG, Dongguan (CN); Bin LIANG, Dongguan (CN)

(21) Appl. No.: 18/800,300

(22) Filed: Aug. 12, 2024

Related U.S. Application Data
(63) Continuation of application No. PCT/CN2022/078495, filed on Feb. 28, 2022.

(51) Int. Cl. H04W 72/231; H04L 27/26; H04W 72/12

(52) U.S. Cl. CPC H04W 72/231; H04L 27/26025; H04W 72/12

(57) ABSTRACT

A wireless communication method includes: receiving, by a terminal device, first downlink control information (DCI) transmitted by a network device, the first DCI being used for scheduling channels of at least two first cells.

### CROSS-REFERENCE TO RELATED APPLICATION

This application is a Continuation Application of PCT/CN2022/078495 filed Feb. 28, 2022, which is incorporated herein by reference in its entirety.

### TECHNICAL FIELD

Embodiments of the present application relate to the technical field of mobile communication, in particular, to wireless communication methods and wireless communication devices.

### BACKGROUND

In a mobile communication system, a physical downlink control channel (PDCCH) transmitted by a base station carries downlink control information (DCI), which is used to indicate information such as time-frequency resources of a physical downlink shared channel (PDSCH) or a physical uplink shared channel (PUSCH). However, the base station does not indicate the specific time-frequency resource location for transmitting the PDCCH to a terminal device, and thus the terminal device needs to blindly detect the PDCCH. When the terminal device blindly detects the PDCCH, it needs to blindly detect the PDCCH in a search space configured by the base station.

Here, a cell carrying the DCI is referred to as a scheduling cell, and a cell to which the PDSCH or PUSCH indicated by the DCI belongs is referred to as a scheduled cell. In this way, the scheduled cell is scheduled through the scheduling cell.

### SUMMARY

A wireless communication method provided by embodiments of the present application includes:
receiving, by a terminal device, first downlink control information (DCI) transmitted by a network device, where the first DCI is used for scheduling channels of at least two first cells.

A wireless communication method provided by embodiments of the present application includes:
transmitting, by a network device, first downlink control information (DCI) for scheduling channels of at least two first cells to a terminal device.

A terminal device provided by embodiments of the present application includes:
a first receiving module, configured to receive first downlink control information (DCI) transmitted by a network device, the first DCI being used for scheduling channels of at least two first cells.

A network device provided by embodiments of the present application includes:
a first transmitting module, configured to transmit first downlink control information (DCI) to a terminal device, the first DCI being used for scheduling channels of at least two first cells

A communication device provided by embodiments of the present application may be the terminal device or the network device in the above solutions, and the communication device includes a processor and a memory. The memory is configured to store a computer program, and the processor is configured to call and run the computer programs stored in the memory to perform the wireless communication methods described above.

A chip provided by embodiments of the present application is used to implement the wireless communication methods described above.

Specifically, the chip includes a processor configured to call and run a computer program from a memory to cause a device installed with the chip to perform the wireless communication methods described above.

A non-transitory computer-readable storage medium provided by embodiments of the present application is configured to store a computer program, and the computer program causes a computer to perform the wireless communication methods described above.

A computer program product provided by embodiments of the present application includes computer program instructions, and the computer program instructions cause a computer to perform the wireless communication methods described above.

A computer program provided by embodiments of the present application, when executed by a computer, causes the computer to execute the wireless communication methods described above.

### BRIEF DESCRIPTION OF THE DRAWINGS

The accompanying drawings described here are intended to provide further understanding of the present application, which form part of the present application. The illustrative embodiments of the present application and their description are intended to explain the present application and do not constitute an undue limitation of the present application. In the accompanying diagrams:

FIG. 1 is a schematic diagram illustrating an application scenario of embodiments of the present application;

FIG. 2 is an optional schematic flow diagram of a wireless communication method provided by embodiments of the present application;

FIG. 3 is an optional schematic flow diagram of a wireless communication method provided by embodiments of the present application;

FIG. 4 is an optional schematic diagram illustrating a second scheduling relationship provided by embodiments of the present application;

FIG. 5 is an optional schematic diagram illustrating a first scheduling relationship provided by embodiments of the present application;

FIG. 6 is an optional schematic diagram illustrating a third scheduling relationship provided by embodiments of the present application;

FIG. 7 is an optional schematic diagram illustrating a first scheduling relationship provided by embodiments of the present application;

FIG. 8 is an optional schematic diagram illustrating a first scheduling relationship provided by embodiments of the present application;

FIG. 9 is an optional schematic diagram illustrating a third scheduling relationship provided by embodiments of the present application;

FIG. 10 is an optional schematic block diagram of a terminal device provided by embodiments of the present application;

FIG. 11 is an optional schematic block diagram of a network device provided by embodiments of the present application;

FIG. 12 is a schematic block diagram of a communication device provided by embodiments of the present application;

FIG. 13 is a schematic block diagram of a chip according to embodiments of the present application; and

FIG. 14 is a schematic block diagram of a communication system provided by embodiments of the present application.

### DETAILED DESCRIPTION

Technical solutions in the embodiments of the present application will be described below with reference to the accompanying drawings in the embodiments of the present application. It is apparent that the embodiments described are some rather than all of the embodiments of the present application. Based on the embodiments of the present application, all other embodiments obtained by a person of ordinary skill in the art fall within the protection scope of the present application.

The present application provides a wireless communication method, which includes:
receiving, by a terminal device, first downlink control information (DCI) transmitted by a network device, the first DCI being used for scheduling channels of at least two first cells.

In some embodiments, in a first scheduling relationship, scheduling cells corresponding to all of the at least two first cells are same.

In some embodiments, the terminal device does not expect that scheduling cells corresponding to all of the at least two first cells are not a same scheduling cell.

In some embodiments, the terminal device does not report first capability indication information to the network device.

In some embodiments, in a first scheduling relationship, the scheduling cells corresponding to all of the at least two first cells are the same or not a same scheduling cell.

In some embodiments, the terminal device reports first capability indication information to the network device.

In some embodiments, the first capability indication information is used to indicate that the terminal device supports at least one of:
that one DCI schedules channels of at least two scheduled cells, and scheduling cells corresponding to all of the at least two scheduled cells are not a same scheduling cell; or
that one scheduled cell is scheduled by at least two scheduling cells.

In some embodiments, in a first scheduling relationship, first parameters corresponding to scheduling cells corresponding to all of the at least two first cells are same, the first parameters are sub-carrier spaces, or the first parameters are used to define sub-carrier spaces and/or cyclic prefixes.

In some embodiments, the terminal device does not expect that first parameters corresponding to scheduling cells corresponding to all of the at least two first cells are not a same first parameter.

In some embodiments, the terminal device does not report second capability indication information to the network device.

In some embodiments, in a first scheduling relationship, first parameters corresponding to scheduling cells corresponding to all of the at least two first cells are same or not a same first parameter, the first parameters are sub-carrier spaces, or the first parameters are used to define sub-carrier spaces and/or cyclic prefixes.

In some embodiments, the terminal device reports second capability indication information to the network device.

In some embodiments, the second capability indication information indicates that the terminal device supports at least one of:
that one DCI schedules channels of at least two scheduled cells, and first parameters corresponding to scheduling cells corresponding to all of the at least two scheduled cells are not a same first parameter; or
that one scheduled cell is scheduled by at least two scheduling cells, first parameters corresponding to the at least two scheduling cells being not a same first parameter.

In some embodiments, the first scheduling relationship is configured by the network device via higher layer signaling.

In some embodiments, in the first scheduling relationship, one scheduled cell corresponds to one scheduling cell.

In some embodiments, the method further includes:
determining based on an adjustment coefficient, by the terminal device, a maximum value of a quantity of candidate physical downlink control channels (PDCCHs) or non-overlapped control channel elements (CCEs) to be monitored on an active bandwidth part (BWP) of a second cell or a second cell group, where the second cell group includes at least two second cells, first parameters corresponding to the at least two second cells are same, and the second cell is any scheduling cell.

In some embodiments, the adjustment coefficient corresponds to the second cell or the second cell group, or the adjustment coefficient corresponds to a first parameter corresponding to the second cell or the second cell group; and the first parameter is a sub-carrier space, or the first parameter is used to define a sub-carrier space and/or a cyclic prefix.

In some embodiments, the adjustment coefficient is used for adjustment of a first quantity, the first quantity is a quantity of scheduled cells corresponding to the second cell or the second cell group, or the first quantity is a quantity of scheduled cells corresponding to a second parameter, and the second parameter is a first parameter corresponding to the second cell or the second cell group.

In some embodiments, the adjustment coefficient is used to adjust the first quantity to a second quantity, the second quantity is greater than or equal to the first quantity, and the second cell or the second cell group includes a third cell used for carrying the first DCI.

In some embodiments, the adjustment coefficient is used to adjust the first quantity to a third quantity, the third quantity is less than or equal to the first quantity, the second cell or the second cell group does not include a third cell used for carrying the first DCI.

In some embodiments, a way of determining the adjustment coefficient includes:
pre-defining in a protocol; or,
configuring by the network device.

In some embodiments, first parameters corresponding to scheduling cells corresponding to all of the at least two first cells are not a same first parameter, the first parameters are sub-carrier spaces, or the first parameters are used to define sub-carrier spaces and/or cyclic prefixes.

The present application further provides a wireless communication method, which includes:
transmitting, by a network device, first downlink control information (DCI) for scheduling channels of at least two first cells to a terminal device.

In some embodiments, in a first scheduling relationship, scheduling cells corresponding to all of the at least two first cells are same.

In some embodiments, the network device does not receive first capability indication information reported by the terminal device.

In some embodiments, in a first scheduling relationship, scheduling cells corresponding to all of the at least two first cells are same or not a same scheduling cell.

In some embodiments, the network device receives first capability indication information reported by the terminal device.

In some embodiments, the first capability indication information is used to indicate that the terminal device supports at least one of:
that one DCI schedules channels of at least two scheduled cells, and scheduling cells corresponding to all of the at least two scheduled cells are not a same scheduling cell; or
that one scheduled cell is scheduled by at least two scheduling cells.

In some embodiments, in a first scheduling relationship, first parameters corresponding to scheduling cells corresponding to all of the at least two first cells are same, the first parameters are sub-carrier spaces, or the first parameters are used to define sub-carrier spaces and/or cyclic prefixes.

In some embodiments, the network device does not expect that first parameters corresponding to scheduling cells corresponding to all of the at least two first cells are not a same first parameter.

In some embodiments, the network device does not receive second capability indication information reported by the terminal device.

In some embodiments, in a first scheduling relationship, first parameters corresponding to scheduling cells corresponding to all of the at least two first cells are same or not a same first parameter, the first parameters are sub-carrier spaces, or the first parameters are used to define sub-carrier spaces and/or cyclic prefixes.

In some embodiments, the network device receives second capability indication information reported by the terminal device.

In some embodiments, the second capability indication information indicates that the terminal device supports at least one of:
that one DCI schedules channels of at least two scheduled cells, and first parameters corresponding to scheduling cells corresponding to all of the at least two scheduled cells are not a same first parameter; or
that one scheduled cell is scheduled by at least two scheduling cells, first parameters corresponding to the at least two scheduling cells being not a same first parameter.

In some embodiments, the first scheduling relationship is configured by the network device via higher layer signaling.

In some embodiments, in the first scheduling relationship, one scheduled cell corresponds to one scheduling cell.

In some embodiments, the method further includes:
configuring, by the network devie, an adjustment coefficient to the terminal device, where the adjustment coefficient is used to determine a maximum value of a quantity of candidate physical downlink control channels (PDCCHs) or non-overlapped control channel elements (CCEs) to be monitored by the terminal device on an active bandwidth part (BWP) of a second cell or a second cell group, the second cell group includes at least two second cells, first parameters corresponding to the at least two second cells are same, and the second cell is any scheduling cell.

In some embodiments, the adjustment coefficient corresponds to the second cell or the second cell group, or the adjustment coefficient corresponds to a first parameter corresponding to the second cell or the second cell group; and the first parameter is a sub-carrier space, or the first parameter is used to define a sub-carrier space and/or a cyclic prefix.

In some embodiments, the adjustment coefficient is used for adjustment of a first quantity, the first quantity is a quantity of scheduled cells corresponding to the second cell or the second cell group, or the first quantity is a quantity of scheduled cells corresponding to a second parameter, and the second parameter is a first parameter corresponding to the second cell or the second cell group.

In some embodiments, the adjustment coefficient is used to adjust the first quantity to a second quantity, the second quantity is greater than or equal to the first quantity, and the second cell or the second cell group includes a third cell used for carrying the first DCI.

In some embodiments, the adjustment coefficient is used to adjust the first quantity to a third quantity, the third quantity is less than or equal to the first quantity, the second cell or the second cell group does not include a third cell used for carrying the first DCI.

In some embodiments, first parameters corresponding to scheduling cells corresponding to all of the at least two first cells are not a same first parameter, the first parameters are sub-carrier spaces, or the first parameters are used to define sub-carrier spaces and/or cyclic prefixes.

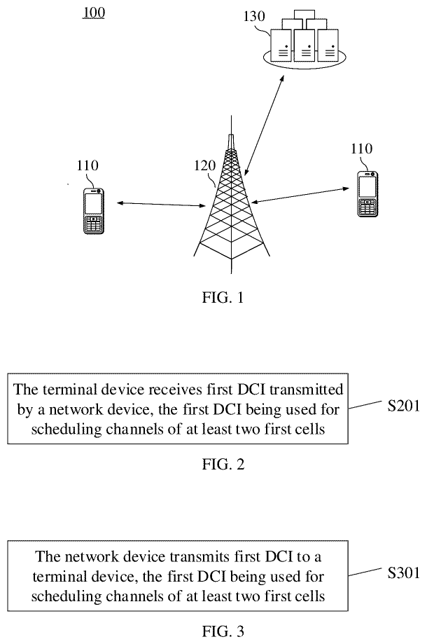

FIG. 1 is a schematic diagram illustrating an application scenario of the present application.

As shown in FIG. 1, a communication system 100 may include a terminal device 110 and a network device 120. The network device 120 may communicate with the terminal device 110 through an air interface. Multi-service transmission is supported between the terminal device 110 and the network device 120.

It should be understood that the communication system 100 is merely used as an example to describe the embodiments of the present application, but the embodiments of the present application are not limited thereto. That is, the technical solutions of the embodiments of the present application may be applied to various communications systems, such as a long term evolution (LTE) system, an LTE time division duplex (TDD), a universal mobile telecommunication system (UMTS), an Internet of things (IoT) system, a narrow band Internet of things (NB-IoT) system, an enhanced machine-type communications (eMTC) system, a 5G communication system (also referred to as a new radio (NR) communication system), and a future communication system.

In the communication system 100 shown in FIG. 1, the network device 120 may be an access network device that communicates with the terminal device 110. The access network device may provide communication coverage for a particular geographic area and may communicate with the terminal device 110 (e.g., UE) located within the coverage area.

The network device 120 may be an evolutional base station (eNB or eNodeB) in a long term evolution (LTE) system, a next generation radio access network (NG RAN) device, a base station (gNB) in a NR system, a wireless controller in a cloud radio access network (CRAN); or the network device may be a relay station, an access point, a vehicle-mounted device, a wearable device, a hub, a switch, a network bridge, a router, or a network device in a public land mobile network (PLMN) evolved in the future, etc.

The terminal device 110 may be any terminal device, including but not limited to a terminal device in a wired or wireless connection with the network device 120 or other terminal devices.

For example, the terminal device 110 may refer to an access terminal, an UE, a subscriber unit, a subscriber station, a mobile station, a mobile console, a remote station, a remote terminal, a mobile device, a user terminal, a terminal, a wireless communication device, a user agent, or a user apparatus. The access terminal may be a cellular phone, a cordless phone, a session initiation protocol (SIP) phone, an IoT device, a satellite handheld terminal, a wireless local loop (WLL) station, a personal digital assistant (PDA), a handheld device having a wireless communication function, a computing device or other processing device connected to a wireless modem, a vehicle-mounted device, a wearable device, a terminal device in a 5G network, or a terminal device in a future evolution network, etc.

The wireless communication system 100 may also include a core network device 130 which communicates with the base station, which may be a 5G Core network (5GC) device, e.g., an access and mobility management function (AMF), as another example, an authentication server function (AUSF), as still another example, a user plane function (UPF), as still another example, a session management function (SMF). Optionally, the core network device 130 may also be an evolved packet core (EPC) device in an LTE network, for example, a session management function+core packet gateway (SMF+PGW-C) device. It should be understood that SMF+PGW-C may implement both the functions that SMF can implement and the functions that PGW-C can implement. In the evolution process of the network, the core network device may also be called other names, or new network entities may be formed by dividing the functions of the core network, which is not limited in the embodiments of the present application.

The various function units in the communication system 100 may also communicate with each other by establishing connections via next generation (NG) network interfaces.

For example, the terminal device establishes an air interface connection with the access network device via an NR interface for transmission of user-plane data and control-plane signaling. The terminal device may establish a control-plane signaling connection to AMF via a NG interface 1 (N1 for short). The access network device, e.g., a next generation radio access base station (gNB), may establish a user-plane data connection to UPF via a NG interface 3 (N3 for short). The access network device may establish a control-plane signaling connection to AMF via a NG interface 2 (N2 for short). UPF may establish a control-plane signaling connection to SMF via a NG interface 4 (N4 for short). UPF may exchange user-plane data with a data network via a NG interface 6 (N6 for short). AMF may establish a control-plane signaling connection to SMF via a NG interface 11 (N11 for short). SMF may establish a control-plane signaling connection with PCF via a NG interface 7 (N7 for short).

FIG. 1 exemplarily illustrates one network device, one core network device and two terminal devices. Optionally, the wireless communication system 100 may include a plurality of network devices, each of which may have a coverage area in which other quantity of terminal devices may be included, which is not limited in the embodiments of the present application.

It should be noted that FIG. 1 merely exemplarily illustrates a system to which the present application is applicable, and obviously the method in the embodiments of the present application may also be applied to other systems. Furthermore, terms “system” and “network” herein are often used interchangeably herein. The term “and/or” herein is only an association relationship to describe associated objects, which indicates that there may be three kinds of relationships. For example, A and/or B may indicate three cases where: A exists alone, both A and B exist, and B exists alone. In addition, a character “/” herein generally indicates that related objects before and after the character “/” are in an “or” relationship. It should be understood that “indication” involved in the embodiments of the present application may be a direct indication, may be an indirect indication, or may represent an association relationship. As an example, that A indicates B may mean that A indicates B directly, for example, B can be obtained through A; or it may mean that A indicates B indirectly, for example, A indicates C, and B can be obtained through C; or it may mean that there is an association between A and B. It should also be understood that the term “correspond” involved in the embodiments of the present application may mean that there is a direct or indirect correspondence between two elements, or may indicate an association between two elements, or may indicate a relationship of indicating and being indicated, configuring and being configured. It should also be understood that the term “predefined” or “predefined rules” involved in the embodiments of the present application may be achieved by pre-storing corresponding codes, tables or other manners that can be used to indicate relevant information in devices (e.g., including a terminal device and a network device). The specific implementation is not limited in the present application. For example, the “predefined” may refer to those defined in a protocol. It should also be understood that, in the embodiments of the present application, “protocols” may refer to standard protocols in the field of communication, which may include, for example, an LTE protocol, an NR protocol and the relevant protocol applied in the future communication system, which is not limited in the present application.

In order to facilitate understanding of the technical solutions of the embodiments of the present application, related technologies involved in the embodiments of the present application will be described below. The following relevant technologies, as optional solutions, may be arbitrarily combined with the technical solutions of the embodiments of the present application, and these combined solutions all fall within the protection scope of the embodiments of the present application.

### (1) Determination of PDCCH Detection Capability

In order to ensure that the quantity of PDCCH detections configured by the network is within the capability that the terminal can implement, NR protocols have defined a PDCCH detection capability.

In the case where the blind detection or blind channel estimation required for to-be-detected PDCCHs configured by the network exceeds the PDCCH detection capability of a terminal, the terminal stops detecting PDCCHs on the remaining PDCCH candidate resources. For a multi-carrier system, the protocols require that PDCCH candidate resources on configured a secondary cell (SCell) by the network do not exceed the PDCCH detection capability of the terminal. PDCCH candidate resources configured on a Pcell may exceed the PDCCH detection capability of the terminal, however, if the PDCCH detection capability is exceeded, the terminal stops detecting PDCCHs on the remaining PDCCH candidate resources.

For a single-carrier system, the blind detection capability is defined by M_{PDCCH}^{max,slot,μ} and C_{PDCCH}^{max,slot,μ}. The specific values of M_{PDCCH}^{max,slot,μ} and C_{PDCCH}^{max,slot,μ} are listed in Table 1 and Table 2, respectively. M_{PDCCH}^{max,slot,μ} in Table or C_{PDCCH}^{max,slot,μ} in Table 2 or may be pre-configured in the terminal. M_{PDCCH}^{max,slot,μ} refers to the maximum blind detection quantity of the terminal on a carrier. The blind detection quantity is related to the quantity of DCI sizes to be detected, an aggregation level and a size of a candidate position set in each aggregation level. The candidate position set includes a plurality of PDCCH candidate resources, namely PDCCH candidates, and the quantity of PDCCH candidates included in the candidate position set is the size of the candidate position set. For example, if one terminal is configured with two DCI formats, the quantity of DCI sizes to be detected is also 2. If there are two aggregation levels, the size of the candidate position set corresponding to aggregation level 1 is 4, and the size of the candidate position set corresponding to aggregation level 2 is 8, the quantity of blind detections required by the terminal is (4+8)×2=24. C_{PDCCH}^{max,slot,μ} refers to the maximum quantity of non-overlapped control channel elements (CCEs) for blind channel detection on a carrier by the terminal.

For a multicarrier system, since the PDCCH detection capability cannot be increased linearly with an increase in the quantity of carriers, the total capability of PDCCH detection in a multi-carrier case is constrained by the maximum quantity of carriers that constrain the PDCCH detection, which includes the cases as follows.

In the case where the quantity of carriers configured by the terminal is less than or equal to the maximum quantity of carriers of the multi-carrier PDCCH blind detection capability reported by the terminal, the maximum quantity of PDCCH candidates and the quantity of non-overlapped CCEs to be monitored by the terminal are the same as those in the single-carrier system.

In the case where the quantity of carriers configured by the terminal is greater than or equal to the maximum quantity of carriers for the multi-carrier PDCCH blind detection capability reported by the terminal (which is only used to calculate the total capability of PDCCH detection and does not limit the quantity of scheduled carriers), the maximum quantity of PDCCH candidates and the maximum quantity of non-overlapped CCEs to be monitored by the terminal are determined in the following way.

For each scheduled carrier, the quantity of PDCCH blind detections does not exceed min(M_{PDCCH}^{max,slot,μ}, M_{PDCCH}^{total,slot,μ}), and the quantity of non-overlapped CCEs does not exceed min(C_{PDCCH}^{max,slot,μ}, C_{PDCCH}^{total,slot,μ}). The specific values of M_{PDCCH}^{max,slot,μ} and C_{PDCCH}^{total,slot,μ} may be referred to Table 1 and Table 2. The way of determining M_{PDCCH}^{total,slot,μ} and C_{PDCCH}^{total,slot,μ} is as follows:

$${M}_{PDCCH}^{total , slot , μ} = ⌊ {N}_{cells}^{cap} \cdot {M}_{PDCCH}^{ma x , slot , μ} \cdot ( {N}_{cells}^{DL , μ} ) / {\sum }_{j = 0}^{3} {N}_{cells}^{DL , j} ⌋ ,$$

$${C}_{PDCCH}^{total , slot , μ} = ⌊ {N}_{cells}^{cap} \cdot {C}_{PDCCH}^{ma x , slot , μ} \cdot ( {N}_{cells}^{DL , μ} ) / {\sum }_{j = 0}^{3} {N}_{cells}^{DL , j} ⌋ ,$$

where, N_{cells}^{cap} is the maximum quantity of carriers for PDCCH detection reported by the terminal, N_{cells}^{DL,j} is the quantity of scheduled carriers corresponding to a carrier whose parameter set (Numerology) is j, and the Numerology includes u, a sub-carrier space, a cyclic prefix, a TTI length, and a system bandwidth. The range of values for j is the range of values for μ, that are 0 to 3, and μ indicates a sub-carrier space of an active bandwidth part (BWP) of a scheduling carrier, that is, on all scheduling cells of the sub-carrier space of u, the terminal is not required to detect more than M_{PDCCH}^{total,slot,μ} candidates, or is not required to detect more than C_{PDCCH}^{total,slot,μ} non-overlapped CCEs. That is to say, a sub-carrier space of a scheduling cell and the quantity of scheduled cells corresponding to a scheduling cell or a scheduling cell group with the same sub-carrier space will affect M_{PDCCH}^{total,slot,μ} and C_{PDCCH}^{total,slot,μ}.

TABLE 1
Correspondence between M_{PDCCH}^{max, slot, μ} and μ

| μ | M_{PDCCH}^{max, slot, μ} |
|---|---|
| 0 | 44 |
| 1 | 36 |
| 2 | 22 |
| 3 | 20 |

TABLE 2
Correspondence between C_{PDCCH}^{max, slot, μ} and μ

| μ | C_{PDCCH}^{max, slot, μ} |
|---|---|
| 0 | 56 |
| 1 | 56 |
| 2 | 48 |
| 3 | 32 |

The detection capability of PDCCH has been adjusted accordingly considering the enhancement of PDCCH detection capability based on time span, the enhancement of PDCCH detection in multi-transmission point (Transmit/Receive Point, TRP) scenarios, and the application of dual connection (DC) scenarios, which will not be explained in detail here.

### (2) Cross-Carrier Scheduling Configuration

Information element cross carrier scheduling configuration (i.e., IE CrossCarrierSchedulingConfigInformation) is used for configuring a scheduling cell corresponding to a scheduled cell and a value of a carrier indicator field (CIF) corresponding to the scheduled cell in the scheduling cell. The CIF corresponding to the scheduled cell is an indication field in DCI for indicating scheduled carriers. Cross-carrier configuration mainly refers to IE CrossCarrierSchedulingConfig, and other cross-carrier related configuration information is not excluded.

Optionally, the IE CrossCarrierSchedulingConfig may include the following two selected fields: CIF presence field (cif-Presence) and scheduled cell field (scheduled cell). The cif-Presence field is used to indicate whether the current scheduled cell is self-scheduled, and scheduled cell field is used to indicate a scheduled cell corresponding to the scheduled cell. The scheduled cell includes: a field schedulingCellId indicating the scheduling cell and a field cif-InSchedulingCell indicating a CIF value corresponding to the scheduled cell in the scheduling cell.

It can be seen from the CrossCarrierSchedulingConfig configuration that in the standardization process, a scheduled cell can be scheduled by at most one scheduling cell, and that the primary cell (PCell) can be scheduled by two scheduling cells PCell and Cell is gradually additionally supported, which needs to be supported by reporting the corresponding terminal capabilities, and the specific implementation will not be repeated here.

In the related technology, resources scheduled by one DCI are limited to one carrier. In R18, in the case of introducing a scheme in which one DCI schedules PDSCHs/PUSCHs of a plurality of scheduled cells, resources scheduled by one DCI correspond to a plurality of scheduled cells, or in other words, a plurality of scheduled cells correspond to one DCI. For this case of “multiple scheduled cells corresponding to one DCI”, whether multiple scheduled cells scheduled by one DCI need to be restricted, and whether it will affect the division of PDCCH detection capability are basic issues that need to be discussed. The design of the restriction scheme will also affect the complexity of the implementation of the feature of “one DCI schedules multiple scheduled cells”.

It should be noted that in the embodiments of the present application, detection may be understood as monitoring, and detection and monitoring may be replaced with each other.

In order to facilitate understanding of the technical solutions of the embodiments of the present application, the technical solutions of the present application will be described in detail in the following through specific embodiments. The above related technologies, as optional solutions, may be arbitrarily combined with the technical solutions of the embodiments of the present application, and these combined solutions all fall within the protection scope of the embodiments of the present application. The embodiments of the present application include at least part of the following content.

A wireless communication method provided by the embodiments of the present application is applied to a terminal device, and as shown in FIG. 2, the method includes:

S201, receiving, by the terminal device, first DCI transmitted by a network device, the first DCI being used for scheduling channels of at least two first cells.

A wireless communication method provided by the embodiments of the present application is applied to a terminal device, and as shown in FIG. 3, the method includes:

S301, transmitting, by the network device, first DCI to a terminal device, the first DCI being used for scheduling channels of at least two first cells.

The embodiments of the present application further provide a wireless communication method applied to a wireless communication system. The wireless communication system includes a terminal device and a network device. The description of the terminal device is referred to the description of the wireless communication method shown in FIG. 2, and the description of the network device is referred to the description of the wireless communication method shown in FIG. 3. Here, the wireless communication method corresponding to the wireless communication system will not be described in detail.

In the embodiments of the present application, the network device transmits first DCI on PDCCH, and channels scheduled by the first DCI include: PDSCH(s) and/or PUSCH(s). The channel(s) scheduled by the first DCI correspond to at least two first cells.

In one example, the channels scheduled by the first DCI include PDSCH 1, PDSCH 2, PUSCH 1, and PUSCH 2. PDSCH 1 corresponds to Cell 1, PDSCH 2 and PUSCH 2 correspond to Cell 2, and PUSCH3 corresponds to Cell 3. In this case, the at least two first cells corresponding to the channels scheduled by the first DCI include: Cell 1, Cell 2 and Cell 3.

In the embodiments of the present application, a cell carrying the first DCI is a scheduling cell corresponding to the at least two first cells, and each first cell of the at least two first cells is a scheduled cell scheduled by the scheduling cell.

In the embodiments of the present application, a plurality of scheduled cells that may be simultaneously scheduled by a scheduling cell may form a scheduled cell group.

In one example, the at least two first cells corresponding to the channels scheduled by the first DCI include: Cell 1, Cell 2 and Cell 3, and if the first DCI is carried on Cell 1, Cell 1 simultaneously schedules Cell 1, Cell 2 and Cell 3, that is, Cell 1 schedules Cell 1+Cell 2+Cell 3. In this case, Cell 1 is a scheduling cell that simultaneously schedules Cell 1, Cell 2 and Cell 3, and Cell 1+Cell 2+Cell 3 forms a scheduled cell group.

In the embodiments of the present application, one scheduling cell may schedule one or more scheduled cell groups.

In the embodiments of the present application, different cells correspond to different carriers, and cells and carriers may be used interchangeably. Therefore, that the first DCI is used for scheduling channels of at least two first cells may be interpreted as that the first DCI is used for scheduling channels of at least two first carriers, and a scheduled cell group may be interpreted as a scheduled carrier group.

The wireless communication methods provided by the embodiments of the present application may be applied to a carrier aggregation (CA) scenario. A CA system supports self scheduling and cross-carrier scheduling. A plurality of carriers may be included in the CA.

According to solutions provided by the embodiment, DCI is transmitted in a scheduling cell, i.e., a scheduling carrier, and channels scheduled by DCI are channels of a scheduled cell, i.e., channels of a scheduled carrier. Downlink signals and uplink signals within each carrier are limited to an active downlink bandwidth part (DL BWP) and an active downlink bandwidth part (UL BWP), respectively.

In the embodiments of the present application, the relationship between a scheduled cell group and a scheduling cell may be referred to as a second schuduling relationship, that is, the relationship that one scheduling cell in cells configured to the terminal device corresponds to a plurality of scheduled cells is the second scheduling relationship.

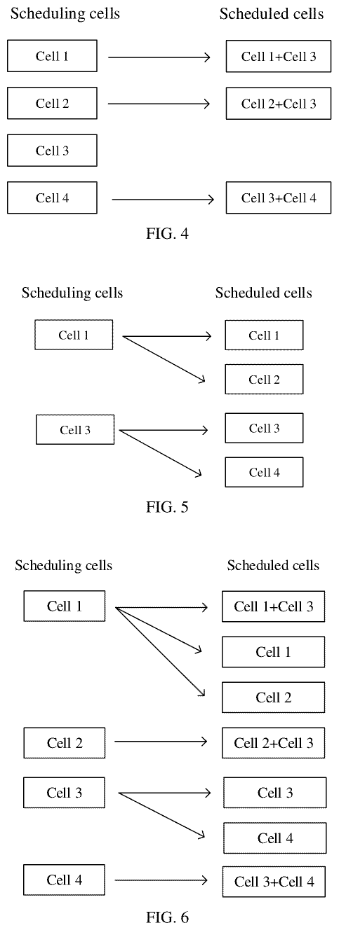

In one example, the second scheduling relationship may be shown in FIG. 4, and the cells configured to the terminal device include: Cell 1, Cell 2, Cell 3 and Cell 4. Scheduled cell groups corresponding to Cell 1, Cell 2 and Cell 4 are Cell 1+Cell 3, Cell 2+Cell 3, and Cell 3+Cell 4, respectively. In the case that the at least two first cells include Cell 1 and Cell 3, the cell carrying the first DCI is Cell 1.

In the embodiments of the present application, the cells configured to the terminal device may be in a first scheduling relationship, and in the first scheduling relationship, one scheduling cell corresponds to one scheduled cell.

In one example, the cells configured to the terminal device include: Cell 1, Cell 2, Cell 3 and Cell 4. The first scheduling relationship may be shown in FIG. 5, scheduled cells corresponding to Cell 1 include Cell 1 and Cell 2, and scheduled cells corresponding to Cell 3 include Cell 3 and Cell 4. In this case, Cell 1 is capable of independently scheduling Cell 1, and also capable of independently scheduling Cell 2. Cell 3 is capable of independently scheduling Cell 3, and also capable of independently scheduling Cell 4.

In the embodiments of the present application, a scheduling relationship between the cells configured to the terminal device, i.e., a third scheduling relationship, may include the first scheduling relationship and the second scheduling relationship. In one example, the cells configured to the terminal device include: Cell 1, Cell 2, Cell 3, and Cell 4, and the third scheduling relationship may be shown in FIG. 6, which includes the first scheduling relationship shown in FIG. 5 and the second scheduling relationship shown in FIG. 4. Scheduled cells corresponding to Cell 1 include: Cell 1+Cell 3, Cell 1 and Cell 3, scheduled cell corresponding to Cell 2 include Cell 2+Cell 3, scheduled cells corresponding to Cell 3 include Cell 3 and Cell 4, scheduled cell corresponding to Cell 4 include Cell 3+Cell 4.

In some embodiments, in the first scheduling relationship, the scheduling cells corresponding to all of the at least two first cells are the same. That is, all of the at least two first cells correspond to the same scheduling cell.

Here, the at least two first cells belong to one scheduled cell group, and if the scheduling cells corresponding to the at least two first cells scheduled by the first DCI are the same, the terminal device supports Capability A, that is, scheduling cells corresponding to all scheduled cells in a scheduled cell group are the same scheduling cell.

In one example, the at least two first cells includes Cell A and Cell B, and the scheduling cell corresponding to Cell A+Cell B is Cell C. In this case, in the first scheduling relationship, the scheduling cell corresponding to Cell A and the scheduling cell corresponding to Cell B are the same, which are Cell C, that is, the scheduling cell corresponding to Cell A is Cell C, and the scheduling cell corresponding to Cell B is Cell C.

In some embodiments, the terminal device does not expect that the scheduling cells corresponding to all of the at least two first cells are not the same scheduling cell.

If the scheduling cells corresponding to all first cells are not the same scheduling cell, and the at least two first cells form a scheduled cell group, the terminal device does not expect that scheduling cells corresponding to all scheduled cells in the scheduled cell group are not the same scheduling cell. In this case, the terminal device supports Capability A, that is, scheduling cells corresponding to all scheduled cells in a scheduled cell group is the same scheduling cell.

In the embodiments of the present application, in the case where the terminal device supports Capability A, when the network device transmits DCI to the terminal device, sheduling cells corresponding to different scheduled cells in at least two scheduled cells corresponding to channels scheduled by the transmitted DCI are the same. When different scheduled cells in at least two scheduled cells corresponding to channels scheduled by the transmitted DCI correspond to different scheduling cells, the terminal device considers that an error case currently occurs, and may autonomously decide the processing way according to setting.

In one example, cells configured to the terminal device includes: Cell 1, Cell 2, Cell 3, Cell 4, Cell 5 and Cell 6, scheduled cells corresponding to Cell 1 include Cell 1 and Cell 2, scheduled cells corresponding to Cell 3 include Cell 3 and Cell 4, and scheduled cells corresponding to Cell 5 include Cell 5 and Cell 6. In this case, the scheduled cell groups may include: Cell 1+Cell 2, Cell 3+Cell 4, and Cell 5+Cell 6, and the terminal device does not expect that a reconbination result of cells in cell combinations of Cell 1+Cell 3, Cell 2+Cell 3, Cell 1+Cell 5, and Cell 3+Cell 6 is a scheduled cell, e.g., {Cell 1, Cell 2}, {Cell 3, Cell 4}, {Cell 5, Cell 6}.

In the embodiments of the present application, if scheduling cells corresponding to all scheduled cells in a scheduled cell group are the same, the scheduled cell group may be a subset of a cell group composed of a plurality of scheduled cells corresponding to the scheduling cell.

In one example, cells configured to the terminal device include Cell 1, Cell 2, Cell 3 and Cell 4, and in the first scheduling relationship, a scheduled cell corresponding to Cell 1 includes Cell 1, Cell 2 or Cell 3, a scheduled cell corresponding to Cell 4 is Cell 4. In this case, a scheduled cell group corresponding to Cell 1 may be a combination of a plurality of scheduled cells in Cell 1, Cell 2 and Cell 3, such as Cell 1+Cell 2, Cell 2+Cell 3, or Cell 1+Cell 2+Cell 3.

In the embodiments of the present application, in the case that one DCI schedules channels of a plurality of scheduled cells, that is, scheduling cells corresponding to all scheduled cells in the scheduled cell group are the same, one scheduled cell corresponds to one scheduling cell, which may avoid the case that one scheduled cell is scheduled by a plurality of scheduling cells, thereby reducing the implementation complexity of scheduling.

In some embodiments, the terminal device does not report first capability indication information to the network device.

In this case, the network device does not receive the first capability indication information reported by the terminal device.

In the case where the terminal device does not report the first capability indication information to the network device, if the network device does not receive the first capability indication information reported by the terminal device, the network device determines that the terminal device does not expect that scheduling cells corresponding to all scheduled cells in a scheduled cell group are not the same scheduling cell, which may be interpreted as that, in this case, the terminal device only supports that the scheduling cells corresponding to all scheduled cells in a scheduled cell group are the same scheduling cell. In the case where DCI transmitted by the network device to the terminal device schedules channels of the scheduled cell group, in the first scheduling relationship, each scheduled cell in the scheduled cell group corresponds to the same scheduling cell.

In some embodiments, in the first scheduling relationship, scheduling cells of all of the at least two first cells are the same or not the same scheduling cell.

Here, the at least two first cells belong to one scheduled cell group, and if the scheduling cells corresponding to the at least two first cells scheduled by the first DCI are not the same scheduling cell, the terminal device supports Capability B, that is, scheduling cells corresponding to all scheduled cells in a scheduled cell group are not the same scheduling cell.

In the embodiments of the present application, Capability A is a basic capability of the terminal device, Capability B is a higher capability than Capability A, and in the case where the terminal device supports Capability B, the terminal device may also support Capability A.

If the terminal device supports Capability B, scheduling cells corresponding to all scheduled cells in a scheduled cell group may be the same scheduling cell or not the same scheduling cell.

In one example, cells configured to the terminal device include Cell 1, Cell 2, Cell 3 and Cell 4, scheduled cells corresponding to Cell 1 include Cell 1, Cell 2 or Cell 3, and a scheduled cell corresponding to Cell 4 is Cell 4. In the case where the terminal device supports Capability B, scheduled cell groups corresponding to Cell 1 includes a combination of a plurality of scheduled cells in Cell 1, Cell 2, Cell 3 and Cell 4, e.g., Cell 1+Cell 4, Cell 2+Cell 3+Cell 4, Cell 1+Cell 2+Cell 3+Cell 4, and the scheduled cell groups corresponding to Cell 1 may further include a combination of a plurality of scheduled cells in Cell 1, Cell 2 and Cell 3, e.g., Cell 1+Cell 2, Cell 2+Cell 3, Cell 1+Cell 2+Cell 3.

In the embodiments of the present application, in the case that one DCI schedules channels of a plurality of scheduled cells, that is, one scheduling cell schedules a scheduled cell group, and the scheduling cells corresponding to all scheduled cells in the scheduled cell group are not the same scheduling cell, the restriction that scheduling cells corresponding to different scheduled cells in a scheduled cell group are the same may be lifted. In this time, the configuration or scheduling flexibility of carriers or cells may be improved.

In some embodiments, the terminal device reports the first capability indication information to the network device.

In this case, the network device receives the first capability indication information transmitted by the terminal device.

In the case where the terminal device supports Capability B, the terminal device may report the first capability indication information to the network device. After receiving the first capability indication information reported by the terminal device, the network device determines that the terminal device supports that scheduling cells corresponding to all scheduled cells in a scheduled cell group are not the same scheduling cell. In the case where the DCI transmitted by the network device to the terminal device schedules channels of the scheduled cell group, scheduling cells corresponding to all scheduled cell in the scheduled cell group may be the same scheduling cell or not the same scheduling cell.

In an embodiment of the present application, the first capability indication information is used to indicate that the terminal device supports at least one of:
that one DCI schedules channels of at least two scheduled cells, and scheduling cells corresponding to all of the at least two scheduled cells are not the same scheduling cell; or
that one scheduled cell is scheduled by at least two scheduling cells.

If the terminal device supports that one DCI schedules channels of at least two scheduled cells, and scheduling cells corresponding to all of the at least two scheduled cells are not the same scheduling cell, the terminal device is considered to support a first capability. The first capability is a capablity of one DCI to schedule channels of at least two scheduled cells and scheduling cells corresponding to all of the at least two scheduled cells being not the same scheduling cell.

If the terminal device supports that one scheduled cell is scheduled by at least two scheduling cells, the terminal device is considered to support a second capability, and the second capability is a capability that one scheduled cell is scheduled by at least two scheduling cells. In this case, one scheduled cell may correspond to at least two scheduling cells.

In the embodiments of the present application, the capability indicated by the first capability indication information may include a variant of the second capability, e.g., in addition to supporting self-scheduling, a scheduled cell may further support a cross-carrier scheduling capability. In the embodiments of the present application, there is no limitation on the variant of one scheduled cell being scheduled by at least two scheduling cells.

In the embodiments of the present application, a scheduling relationship between a scheduled cell group and a scheduling cell is added on the basis of the first scheduling relationship. In the case that scheduling cells corresponding to all scheduled cells in a scheduled cell group are not the same scheduling cell, there must be some scheduled cells in the scheduled cell group, which can be scheduled by more than one scheduling cell, and for the same scheduled cell, the quantity of optional cells for the base station to transmit PDCCH increases, which improves the PDCCH scheduling flexibility and reduces the PDCCH blockage probability.

In some embodiments, in the first scheduling relationship, first parameters corresponding to all of the at least two first cells are the same, and the first parameters are sub-carrier spaces (SCSs), or the first parameters are used to define sub-carrier spaces and/or cyclic prefixes (CPs).

Here, at least two first cells belong to one scheduled cell group, and if the first parameters corresponding to scheduling cells corresponding to the at least two first cells scheduled by the first DCI are the same first parameter, the terminal device supports Capability C, that is, first parameters corresponding to scheduling cells corresponding to all scheduled calls in a scheduled cell group are the same first parameter.

Optionally, in the case where a first parameter is used to define an SCS and/or a cyclic prefix, the first parameter is Numerology.

In one example, the at least two first cells include Cell A and Cell B, and a scheduling cell corresponding to cell A+ cell B is cell C. In this case, in the first scheduling relationship, the first parameter corresponding to the scheduling cell corresponding to Cell A and the first parameter corresponding to the scheduling cell corresponding to Cell are the same, which are first parameter A, and the SCS indicated by first parameter A is 15 kHz, that is, the SCS corresponding to the scheduling cell corresponding to Cell A is 15 kHz, and the SCS corresponding to the scheduling cell corresponding to Cell B is 15 kHz.

In some embodiments, the terminal device does not expect that first parameters corresponding to scheduling cells corresponding to all of the at least two first cells are not the same first parameter.

If first parameters corresponding to scheduling cells corresponding to all first cells are not the same first parameter, and the at least two first cells form a scheduled cell group, then the terminal device does not expect that first parameters corresponding to scheduling cells corresponding to all scheduled cells in the scheduled cell group are not the same first parameter. In this case, the terminal device supports that first parameters corresponding to scheduling cells corresponding to all scheduled cells in the scheduled cell group are the same first parameter.

In the embodiments of the present application, in the case where the terminal device supports Capability C, when the network device transmits DCI to the terminal device, first parameters corresponding to scheduling cells corresponding to different scheduled cell in the at least two scheduled cells corresponding to channels scheduled by the transmitted DCI are the same first parameter. When scheduling cells corresponding to different scheduled cells in at least two scheduled cells corresponding to channels scheduled by the DCI transmitted by the network device correspond to different first parameters, the terminal device considers that an error case currently occurs, and may autonomously decide the processing way according to setting.

In one example, cells configured to the terminal device include: Cell 1, Cell 2, Cell 3, Cell 4, Cell 5 and Cell 6, SCSs corresponding to Cell 1 and Cell 3 are 15 kHz, SCSs corresponding to Cell 2, Cell 4 and Cell 6 are 60 kHz, SCS corresponding to Cell 5 is 30 kHz, scheduled cells corresponding to Cell 1 include Cell 1 and Cell 2, scheduled cells corresponding to Cell 3 include Cell 3 and Cell 4, and scheduled cells corresponding to Cell 5 include Cell 5 and Cell 6. In this case, the terminal device supports combinations of scheduled cells corresponding to a 15 kHz scheduling cell, which are combinations of following scheduled cells: Cell 1, Cell 2, Cell 3 and Cell 4, and the terminal device does not support combinations of cells in a set of {Cell 1, Cell 2, Cell 3, Cell 4} and cells in a set of {Cell 4, Cell 5}, for example, the terminal device does not support the following combinations: Cell 1+Cell 5, Cell 2+Cell 5, Cell 1+Cell 6, and Cell 3+Cell 6.

Optionally, scheduling cell(s) corresponding to the same first parameter include one scheduling cell or a plurality of scheduling cells. In the case that the same first parameter corresponds to a plurality of scheduling cells, the scheduling cell corresponding to the corrseponding scheduled cell group may be any one of the plurality of scheduling cells.

In the embodiments of the present application, in the case that one DCI can schedule channels of a plurality of scheduled cells, that is, a scheduled cell corresponds to a scheduled cell group, the first parameters corresponding to scheduling cells corresponding to all scheduled cells in the scheduled cell group are the same. In this case, the calculation of the PDCCH detection capability of the terminal device on all scheduled cells with sub-carrier spaces corresponding to u is the same with the calculaton in the case “one DCI schedules a channel of a scheduled cell”, and is not affected by “one DCI schedules channels of a plurality of scheduled cells”. Therefore, the division of PDCCH detection capability maximizes the reuse of the existing mechanism, and has good backward compatibility.

In some embodiments, the terminal device does not report second capability indication information to the network device.

In this case, the network device does not receive the second capability indication information reported by the terminal device.

In the case that the terminal device does not report the second capability indication information to the network device, if the network device does not receive the second capability indication information reported by the terminal device, the network device determines that the terminal device does not expect first parameters corresponding to scheduling cells corresponding to all scheduled cells in a scheduled cell group to be the same first parameter, which may be interpreted as that, in this case, the terminal device only supports that first parameters corresponding to scheduling cells corresponding to all scheduled cells in a scheduled cell group are the same first parameter. In the case that DCI transmitted by the network device to the terminal device schedules channels of a scheduled cell group, scheduling cells in the first scheduling relationship that are corresponding to all scheduled cells in a scheduled cell group correspond to the same first parameter.

In some embodiments, in the first scheduling relationship, first parameters corresponding to scheduling cells of all of the at least two first cells are the same or not the same first parameter.

In this case, the terminal device supports Capability D, that is, first parameters that are corresponding to scheduling cells corresponding to all scheduled cell in a scheduled cell group in the first scheduling relationship are not the same first parameter.

In the embodiments of the present application, Capability C is a basic capability of the terminal device, Capability D is a higher capability than Capability C, and int the case where the terminal device supports Capability C, the terminal device may also support Capability D.

If the terminal device supports Capability D, first parameters that are corresponding to scheduling cells corresponding to all scheduled cell in a scheduled cell group in the first scheduling relationship may be the same first parameter or not the same first parameter.

In one example, cells configured to the terminal device include: Cell 1, Cell 2, Cell 3, Cell 4, Cell 5 and Cell 6, SCSs corresponding to Cell 1 and Cell 3 are 15 kHz, SCSs corresponding to Cell 2, Cell 4 and Cell 6 are 60 kHz, SCS corresponding to Cell 5 is 30 kHz, scheduled cells corresponding to Cell 3 include Cell 3 and Cell 4, and scheduled cells corresponding to Cell 5 include Cell 5 and Cell 6. In the case that the terminal device supports Capability D, a scheduled cell group may be a combination of cells in a set of {Cell 1, Cell 2, Cell 3, Cell 4} and cells in a set of {Cell 4, Cell 5}, such as Cell 1+Cell 5, Cell 2+Cell 6, or Cell 3+Cell 4+Cell 5, and the combination of scheduled cells may further include a combination of a plurality of cells in a set of {Cell 1, Cell 2, Cell 3, Cell 4} and a combination of a plurality of cells in a set of {Cell 5, Cell 6}, such as Cell 1+Cell 2, Cell 3+Cell 4, or Cell 5+Cell 6.

In the embodiments of the present application, in the case that one DCI schedules channels of a plurality of scheduled cells, that is, one scheduling cell schedules a scheduled cell group, and first parameters corresponding to scheduling cells corresponding to all scheduled cells in the scheduled cell group are not the same first parameter, the restriction that first parameters corresponding to scheduling cells corresponding to different scheduled cells in a scheduled cell group are not the same first parameter may be lifted, which may improve the configuration/scheduling flexibility of carriers or cells, and reduce PDCCH blockage probability.

In some embodiments, the terminal device reports second capability indication information to the network device.

In this case, the network device receives the second capability indication information transmitted by the terminal device.

In the case where the terminal device supports Capability D, the terminal device may report the second capability indication information to the network device. After receiving the second capability indication information reported by the terminal device, the network device determines that the terminal device supports that scheduling cells corresponding to all scheduled cells in a scheduled cell group are not the same scheduling cell. In the case where the DCI transmitted by the network device to the terminal device schedules channels of the scheduled cell group, first parameters that are corresponding to scheduled cells corresponding to all scheduled cells in a scheduled cell group in a first scheduling relationship are not the same first parameter.

In embodiments of the present application, the second capability indication information indicates that the terminal device supports at least one of:
that one DCI schedules channels of at least two scheduled cells, and first parameters corresponding to scheduling cells corresponding to all of the at least two scheduled cells are not a same first parameter; or
that one scheduled cell is schuduled by at least two scheduling cells, first parameters corresponding to the at least two scheduling cells being not a same first parameter.

If the terminal device supports that one DCI schedules channels of at least two scheduled cells, and first parameters that are corresponding to scheduling cells corresponding to all of the at least two scheduled cells are not the same first parameter, the terminal device is considered to support a third capability. The third capability is a capability that one DCI schedules channels of at least two scheduled cells and first parameters that are corresponding to scheduling cells corresponding to all of the at least two scheduled cells are not the same first parameter.

If the terminal device supports that one scheduled cell is scheduled by at least two scheduling cells, and first parameters corresponding to the at least two scheduling cells are not the same first parameter, the terminal device is considered to support a second capability. The second capability is a capability that one scheduled cell is scheduled by at least two scheduling cells and first parameters corresponding to the at least two scheduling cells are not the same first parameter. In this case, one scheduled cell may correspond to at least two scheduled cells with different first parameters.

In embodiments of the present application, the capability indicated by the second capability indication information may include a variant of a fourth capability, e.g., in addition to supporting self-scheduling, a scheduled cell may further support a cross-carrier scheduling capability, and the first parameter corresponding to the scheduled cell is different from the first parameter corresponding to the cell of across scheduling. In the embodiments of the present application, there is no limitation on the variant of the fourth capability.

In some embodiments, the first scheduling relationship is configured by the network device via higher layer signaling. The first scheduling relationship may be configured via cross-carrier scheduling configuration information.

In the embodiments of the present application, the second scheduling relationship of one scheduling cell corresponding to one scheduled cell group may be configured by the network device via higher layer signaling, or may be configured by the terminal device based on the first scheduling relationship configured via higher layer signaling, so as to form the third scheduling relationship based on the second scheduling relationship and the first scheduling relationship.

In some embodiments, the terminal device receives cross-cell scheduling configuration information transmitted by the network device, and the cross-cell scheduling configuration information is used to configure a scheduling cell corresponding to scheduled cells. The cross-cell scheduling configuration information is used to indicate a third scheduling relationship, which includes a first scheduling relationship and/or a second scheduling relationship. In the first scheduling relationship, one DCI schedules a channel of a scheduled cell. In the second scheduling relationship, one DCI schedules channels of at least two scheduled cells.

In some embodiments, the terminal device determines, according to an adjustment coefficient, the maximum value of the quantity of candidate physical downlink control channels (PDCCHs) or non-overlapped control channel elements (CCEs) to be monitored on an active bandwidth part (BWP) of a second cell or a second cell group. The second cell group includes at least two second cells corresponding to the same first parameter, and the second cell is any scheduling cell.

Optionally, configuration of the adjustment coefficient includes:
configuration manner 1: pre-defining in a protocol; or,
configuration manner 2: configuring by the network device.

In the case where the configuration manner of the adjustment coefficient is the configuration manner 2, the network device performs the following processing:

configuring, by the network device, an adjustment coefficient to the terminal device, the adjustment coefficient being used to determine the maximum value of the quantity of candidate physical downlink control channels (PDCCHs) or non-overlapped control channel elements (CCEs) to be monitored by the terminal device on an active BWP of a second cell or a second cell group, the second cell group including at least two second cells corresponding to the same first parameter, and the second cell being any scheduling cell.

In the embodiments of the present application, a scheduling cell may schedule a scheduled cell group, and the terminal device determines, according to the adjustment coefficient, the maximum quantity of candidate physical downlink control channels (PDCCHs), i.e., the maximum quantity of PDCCH candicates, or non-overlapped CCEs to be monitored on an active BWP of the second cell or the second cell group.

Here, the second cell is any one of at least one scheduling cell in the third scheduling relationship of cells that is configured to the terminal device. The at least one scheduling cell includes a third cell, and the third cell is a cell for carrying the first DCI. When a plurality of second cells with the same first parameters are included in the third scheduling relationship, the plurality of second cells form a second cell group.

In one example, when cells configured to the terminal device include Cell 1, Cell 2, Cell 3, Cell 4, Cell 5 and Cell 6, SCSs corresponding to Cell 1 and Cell 3 are 15 kHz, SCSs corresponding to Cell 2, Cell 4 and Cell 6 are 60 kHz, SCS corresponding to Cell 5 is 30 kHz, and the scheduling cells include Cell 1, Cell 3 and Cell 5, the second cell includes Cell 5, and the second cell group includes {Cell 1, Cell 3}.

Optionally, after the terminal device determines the maximum quantity of candidate PDCCHs to be monitored on an active BWP of a second cell or a second cell group based on the adjustment coefficient, the quantity of blind PDCCH detections on the active BWP of the second cell or the second cell group does not exceed the maximum quantity of candidate PDCCHs determined based on the adjustment coefficient.

Optionally, after the terminal device determines the maximum quantity of non-overlapped CCEs to be monitored on an active BWP of a second cell or a second cell group based on the adjustment coefficient, the detection quantity of non-overlapped CCEs on the active BWP of the second cell or the second cell group does not exceed the maximum quantity of non-overlapped CCEs to be monitored that is determined based on the adjustment coefficient and the maximum quantity of non-overlapped CCEs to be monitored on an active BWP of one cell.

In the embodiments of the present application, the introduction of the adjustment coefficient ensures that PDCCH detection capabilities are allocated according to the data transmission requirements of different scheduled cells.

In some embodiments, the adjustment coefficient corresponds to the second cell or the second cell group, or the adjustment coefficient corresponds to a first parameter corresponding to the second cell or the second cell group, and the first parameter is a sub-carrier space, or the first parameter is used to define a sub-carrier space and/or a cyclic prefix.

In the embodiments of the present application, the adjustment coefficient may be configured based on a cell or cell group, or may be configured based on a first parameter, that is, per-(numerology of) scheduling cell(s).

Optionally, when adjustment coefficients are configured according to second cells or second cell groups, and there is a correspondence between the adjustment coefficients and the second cells or the second cell groups, the adjustment coefficients corresponding to all second cells or second cell groups are configured separately. In this case, the terminal device may determine an adjustment coefficient according to a second cell or a second cell group.

In one example, when cells configured to the terminal device include Cell 1, Cell 2, Cell 3, Cell 4, Cell 5 and Cell 6, SCSs corresponding to Cell 1 and Cell 3 are 15 kHz, SCSs corresponding to Cell 2, Cell 4 and Cell 6 are 60 kHz, and SCS corresponding to Cell 5 is 30 kHz, the scheduling cells include Cell 1, Cell 3 and Cell 5, the second cells include Cell 1, Cell 3 and Cell 5, and the adjustment coefficients corresponding to Cell 1, Cell 3 and Cell 5 are adjustment coefficient 1, adjustment coefficient 2 and adjustment coefficient 3, respectively.

Optionally, when adjustment coefficients are configured according to first parameters, and there is a correspondence between the adjustment coefficients and the first parameters, the adjustment coefficients of all first parameters are configured separately. In this case, the terminal device may determine an adjustment coefficient according to a first parameter corresponding to a second cell or a second cell group.

In one example, when cells configured to the terminal device include Cell 1, Cell 2, Cell 3, Cell 4, Cell 5 and Cell 6, SCSs corresponding to Cell 1 and Cell 3 are 15 kHz, SCSs corresponding to Cell 2, Cell 4 and Cell 6 are 60 kHz, and SCS corresponding to Cell 5 is 30 kHz, an adjustment coefficient corresponding to 15 kHz is adjustment coefficient 4, an adjustment coefficient corresponding to 30 kHz is adjustment coefficient 5, and an adjustment coefficient corresponding to 60 kHz is adjustment coefficient 6.

In the embodiments of the present application, a reference adjustment coefficient γ may be configured, and in this case, an adjustment coefficient may be a product of the reference adjustment coefficient γ and a reference multiple n. Different second cell groups or second cells or different first parameters may correspond to different adjustment multiples n.

In the embodiments of the present application, configuring the adjustment coefficients based on scheduling cells, scheduling cell groups or first parameters may reduce the signaling overhead, and simplify the allocation of PDCCH detection capability.

In some embodiments, the adjustment coefficient is used to adjust a first quantity. The first quantity is the quantity of scheduled cells corresponding to a second cell or second cell groups or the quantity of scheduled cells corresponding to a second parameter, and the second parameter is a first parameter corresponding to the second cell or second cell group.

The first quantity may be noted as N_{cells}^{DL,j}, which means the quantity of scheduled cells corresponding to the scheduling cell or scheduling cell group corresponding to the first parameter j. N_{cells}^{DL,j} is used to determine M_{PDCCH}^{max,slot,μ} or C_{PDCCH}^{max,slot,μ}.

In one example, as shown in FIG. 8, scheduling cells include Cell 1, Cell 3 and Cell 5, and if SCSs of Cell 1, Cell 3 and Cell 5 are 15 kHz, and SCS of Cell 5 is 30 kHz, for a second cell group formed by Cell 1 and Cell 3, the first quantity is the quantity of scheduled cells corresponding to Cell 1 and Cell 3, i.e., 4; and for the second cell Cell 5, the first quantity is the quantity of scheduled cells corresponding to Cell 5, i.e., 2.

In one example, as shown in FIG. 8, scheduling cells include Cell 1, Cell 3 and Cell 5, and if SCSs of Cell 1, Cell 3 and Cell 5 are 15 kHz, and SCS of Cell 5 is 30 kHz, for 15 kHz, the corresponding first quantity is the quantity of scheduled cells corresponding to Cell 1 and Cell 3, i.e., 4; and for 30 kHz, the first quantity is the quantity of scheduled cells corresponding to Cell 5, i.e., 2.

Here, a way of using the adjustment coefficient to adjust the first quantity may include performing at least one of the following calculations on first data with the adjustment coefficient: addtion, subtraction, multiplication or division. The adjustment way is not limited in the embodiments of the present application.

In the embodiments of the present application, a scheduling cell corresponding to a scheduled cell group may be any scheduling cell in the first scheduling relationship.

In one example, cells configured to the terminal device include Cell 1, Cell 2, Cell 3, Cell 4, Cell 5 and Cell 6, Cell 1 schedules Cell 1 and Cell 2, Cell 3 schedules Cell 3 and Cell 4, and Cell 5 schedules Cell 5 and Cell 6, the scheduling cells of Cell 1+Cell 3 may be Cell 1, Cell 3, or Cell 5.

In the embodiments of the present application, by adding the second scheduling relationship on the basis of the first scheduling relationship, channels corresponding to a scheduled cell group is beared by a corresponding scheduling cell, which may affect the maximum quantity of candidate PDCCHs and non-overlapped CCEs to be monitored on an active BWP of a scheduling cell corresponding to a first scheduled cell or an active BWP of a scheduling cell corresponding to a scheduled cell group. The terminal device may determine an adjustment coefficient based on a first parameter corresponding to a scheduling cell or scheduling cell group or a first parameter corresponding to a scheduling cell or scheduling cell group, and adjust the first quantity based on the determined adjustment coefficient, so as to determine the maximum quantity of candidate PDCCHs and non-overlapped CCEs on the active BWP of the scheduling cell or scheduling cell group based on the adjusted first quantity. The first scheduled cell is a scheduled cell in the scheduled cell group.

In the embodiments of the present application, adjustment strategies for adjusting a first quantity with an adjustment coefficient may include one or more of the following two adjustment strategies:
adjustment strategy 1 of adjusting the first quantity to a second quantity using the adjustment coefficient, where the second quantity is greater than or equal to the first quantity, a second cell or second cell group includes a third cell for carrying the first DCI; and
adjustment strategy 2 of adjusting the first quantity to a third quantity using the adjustment coefficient, where the third quantity is less than or equal to the first quantity, a second cell or second cell group does not include a third cell for carrying the first DCI.

According to the adjustment strategy 1, a second cell or second cell group includes a third cell, in this case, the second cell or second cell group bears channels of at least two first cells, that is, channels of a cheduled cell group. In one example, Cell 1 schedules a cell group formed by Cell 1 and Cell 5, i.e., SCS of Cell 1 is 15 kHz, and scheduling cells of 15 kHz further include Cell 3, a second cell group formed by Cell 1 and Cell 3 assumes channels of Cell 1+Cell 3. In the case that scheduled cells corresponding to the second cell or second cell group include all the first scheduled cells, the data scheduled by the second cell or second cell group remains unchanged, and the second quantity is equal to the first quantity. In the case where scheduled cells corresponding to the second cell or second cell group do not include any first scheduled cell, the data scheduled by the second cell or second cell group is increased, and the second quantity is greater than the first quantity. For example, continuing the above example, if the scheduling cell corresponding to Cell 1 is Cell 1 and the scheduling cell corresponding to Cell 5 is Cell 3, the data scheduled by the second cell group formed by Cell 1 and Cell 3 remains unchanged. If the scheduling cell corresponding to Cell 1 is Cell 1 and the scheduling cell corresponding to Cell 5 is Cell 5, the data scheduled by the second cell group formed by Cell 1 and Cell 3 is increased by channels of Cell 5, that is, the data scheduled by the second cell group formed by Cell 1 and Cell 3 is increased.

According to the adjustment strategy 2, a second cell or the second cell group does not include a third cell, in this case, the second cell or second cell group does not bear channels of at least two first cells, that is, channels of a scheduled cell group. In one example, Cell 1 schedules a cell group formed by Cell 1 and Cell 5, i.e., SCS of Cell 1 is 15 kHz, and scheduling cells of 15 kHz further include Cell 3, a second cell group formed by Cell 1 and Cell 3 bears channels of Cell 1+Cell 3. If the second cells configured by the terminal device further include Cell 5 and cell 7, the scheduled cells corresponding to Cell 5 include Cell 5 and Cell 6, and the scheduled cells corresponding to Cell 7 include Cell 7 and Cell 8, second cells Cell 5 and Cell 7 do not bear the data of Cell 1 and Cell 5. In the case that scheduled cells corresponding to the second cell or second cell group do not include all the first scheduled cells, the data scheduled by the second cell or second cell group is unchanged, and the third quantity is equal to the first quantity. In the case that scheduled cells corresponding to the second cell or second cell group include any one of the scheduled cells, the channels scheduled by the second cell or second cell group are reduced, and the third quantity is less than the first quantity. For example, continuing the above example, if the scheduled cells corresponding to Cell 7 are still Cell 7 and Cell 8, and the data scheduled by Cell 7 remains unchanged. If Cell 5 serves as a scheduled cell, part data of Cell 5 is scheduled by Cell 1, and the data of the scheduled cell Cell 5 corresponding to Cell 5 is reduced.

In one example, cells configured to the terminal device include Cell 1, Cell 2, Cell 3, Cell 4, Cell 5 and Cell 6, Cell 1 schedules Cell 1 and Cell 2, Cell 3 schedules Cell 3 and Cell 4, Cell 5 schedules Cell 5 and Cell 6, Cell 1 and Cell 3 form a second cell group 1, and Cell 5 is a second cell 2. If Cell 1 and Cell 3 form a scheduled cell group, Cell 1+Cell 3 may be scheduled by Cell 1 or Cell 3, and in this case, the second cell group 1 still schedules the data of each cell in a set of {Cell 1, Cell 2, Cell 3, Cell 4}. Therefore, the data scheduled by the second cell group 1 is unchanged, and the second quantity corresponding to the second cell group 1 is equal to the first quantity corresponding to the second cell group 1. Scheduled cells corresponding to the second cell 2 (i.e., Cell 5) are Cell 5 and Cell 6, and the data scheduled by the second cell 2 is unchanged. Therefore, the second quantity corresponding to the second cell 2 is unchanged, and the third quantity corresponding to the second cell 2 is equal to the first quantity corresponding to the second dell 2.

In one example, cells configured to the terminal device include: Cell 1, Cell 2, Cell 3, Cell 4, Cell 5, Cell 6, Cell 7 and Cell 8, Cell 1 schedules Cell 1 and Cell 2, Cell 5 schedules Cell 5 and Cell 6, Cell 7 schedules Cell 7 and Cell 8, Cell 1 and Cell 3 form a second cell group 1, Cell 5 serves as a second cell 2, and Cell 7 serves as a second cell 3. If Cell 1 and Cell 5 form a scheduled cell group, when Cell 1+Cell 5 is scheduled by Cell 1, part data of Cell 1 is scheduled by Cell 5. Thus, when the second cell group schedules data of each cell in a set of {Cell 1, Cell 2, Cell 3, Cell 4}, part data of Cell 1 is scheduled by Cell 5. Therefore, the data scheduled by the second cell group 1 is reduced, and the third quantity corresponding to the second cell group 1 is smaller than the first parameter corresponding to the second cell group 1. The scheduled cells corresponding to the second cell 2 (i.e., Cell 5) are Cell 5 and Cell 6, in this case, the data scheduled by Cell 5 further includes the part data of Cell 1, and the data scheduled by Cell 5 is increased. Therefore, the second quantity corresponding to the second cell 2 is greater than the first quantity corresponding to the second dell 2. The scheduled cells corresponding to Cell 7 are Cell 7 and Cell 8, and thus, the data scheduled by Cell 7 is not affected by Cell 1+Cell 5, and the third quantity corresponding to Cell 7 (i.e., the second cell 3) is equal to the first quantity corresponding to the second cell 3.

In some embodiments, first parameters corresponding to scheduling cells corresponding to all first cells are not the same first parameter, and the first parameters are sub-carrier spaces, or the first parameters are used to define sub-carrier spaces and/or cyclic prefixes.

In the embodiments of the present application, in the case where a scheduling cell corresponding to each first cell corresponds to the same first parameter, the quantity of scheduled cells corresponding to the second cell or second cell group does not change, and the scheduled cell group does not change the data beared by each second cell or the second cell group, thus, it is unnecessary to adjust the first quantity corresponding to each second cell or the second cell group.

In the case where first parameters corresponding to all of the at least two first cells are not the same first parameter, the scheduled cell group affects the quantity of scheduled cells corresponding to some second cells or second cell groups, and a first quantity corresponding to each of these second cells or second cell groups is adjusted according to an adjustment coefficient.

In the embodiments of the present application, in the case where in the first scheduling relationship, the third cell is not a scheduling cell, the third cell may be used as a new scheduling cell. In this case, the value of the first quantity corresponding to the third cell may be regarded as a default value, e.g., 0 or 1.

Hereinafter, the wireless communication method provided by the embodiments of the present application will be further described.

The terminal receives the DCI transmitted from the network side, and the DCI is used for scheduling at least two (N) data channels (PDSCHs or PUSCHs), the N data channels corresponding to M carrier/serving cells, where M is less than or equal to N.

The terminal receives cross-carrier scheduling configuration information transmitted from the network side, and the cross-carrier scheduling configuration information is used for configuring a scheduling carrier corresponding to a scheduled carrier.

I. The terminal does not expect that scheduling carriers corresponding to the M carriers are different. That is, only when the scheduling carriers corresponding to the M carriers are the same, the data of the M carriers can be scheduled by the same DCI.

(a) A second terminal capability is defined, the first terminal capability is used for indicating the terminal to support the function of “one DCI schedules data channels of a plurality of carriers”, and the scheduling carrier corresponding to the plurality of carriers is not the same scheduling carrier. Alternatively, a first terminal capability for indicating the terminal to support that one scheduled carrier is scheduled by more than one scheduling carrier.

It shoulded be noted that the first terminal capability includes all the capabilities can indicate that one scheduled carrier is scheduled by more than one scheduling carrier. For example, the PCell may be self scheduled by default, and if the cross-carrier scheduling capability from the SCell to the PCell is supported, it is equivalent to supporting that the PCell can be scheduled by a plurality of carriers. That is, the cross-carrier scheduling capability of the SCell scheduling the PCell is also a variant of the first terminal capability.

In the case that the terminal does not report the first terminal capability and/or the second terminal capability, the terminal does not expect that scheduling carriers corresponding to the M carriers are not the same scheduling carrier.

In the case that the terminal reports the first terminal capability and/or the second terminal capability, the terminal may support that the scheduling carriers corresponding to the M carriers are not the same scheduling carrier.

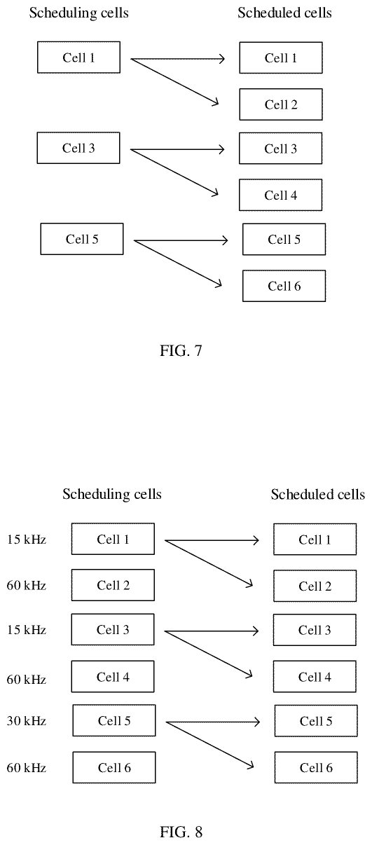

In one example, the network side configures Cell 1 to Cell 6 for the terminal, and the scheduling relationship between Cell 1 to Cell 6 is shown in FIG. 7. The scheduling cells of Cell 1 and Cell 2 are Cell 1, the scheduling cells of Cell 3 and Cell 4 are Cell 3, and the scheduling cells of Cell 5 and Cell 6 are Cell 5. Based on the scheduling relationship shown in FIG. 7, when the function of one DCI scheduling data channels of a plurality of scheduled cells is supported, the plurality of scheduled cells may be: a subset of {Cell 1, Cell 2}, or a subset of {Cell 3, Cell 4}, or a subset of {Cell 5, Cell 6}, in other words, scheduling of cell combinations such as Cell 1+Cell 3, or Cell 1+Cell 5, through one DCI is not supported.

If the scheduling cells corresponding to the M carriers are not the same scheduling cell, there must be some cells in the M carriers which are scheduled by more than one scheduling cell. Based on the scheduling relationship shown in FIG. 7, if it is supported that Cell 1+Cell 5 can be scheduled simultaneously, the following situations may exist: 1) Cell 1 may be scheduled by both Cell 1 and Cell 5; or, 2) Cell 5 may be scheduled by both Cell 1 and Cell 5. Since NR R15/16 only supports that one scheduled cell is scheduled by one scheduled cell, and supporting one scheduled cell to be scheduled by more than one scheduling cell will introduce additional implementation complexity.

II. The terminal does not expect that sub-carrier spaces or numerologies of scheduling cells corresponding to the M cells are not the same sub-carrier space or numerology. That is, only when the sub-carrier spaces or numerologies of the scheduling cells corresponding to the M cells are the same, the data of the M cells can be scheduled by the same DCI.

(a) A fourth terminal capability is defined, the fourth terminal capability is used for indicating that the terminal supports the above-mentioned function of “one DCI schedules data channels of a plurality of cells”, and the sub-carrier spaces or numerologies of the scheduling carriers corresponding to the plurality of cells are not the same sub-carrier space or numerology. Alternatively, a third terminal capability is defined, the third terminal capability is used for indicating that the terminal supports one scheduled cell to be scheduled by more than one scheduling cell, and the sub-carrier spaces or numerologies of the scheduling cells are not the same sub-carrier space or numerology. It is worth to be noted that the third terminal capability includes all variant capabilities that can indicate the above-mentioned function. For example, the PCell may be self scheduled by default, and if the cross-carrier scheduling capability from the SCell to the PCell is supported and the sub-carrier spaces of the SCell and PCell are different, it is equivalent to supporting that one cell is scheduled by more than one cell with different sub-carrier spaces. That is, the cross-carrier scheduling capability of SCell scheduling PCell (SCell and PCell have different sub-carrier spaces) are also a variant of the third terminal capability.

i) In the case that the terminal does not report the third terminal capability and/or the fourth terminal capability, the terminal does not expect that sub-carrier spaces or numerologies of scheduling cells corresponding to the M cells are not the same sub-carrier space or numerology.

ii) In the case that the terminal reports the third terminal capability and/or the fourth terminal capability, the terminal may support that sub-carrier spaces or numerologies of scheduling cells corresponding to the M cells are not the same sub-carrier space or numerology.

In one example, the network side configures Cell 1 to Cell 6 for the terminal, and the sub-carrier spaces/numerologies of Cell 1 to Cell 6 and scheduling relationship between Cell 1 to Cell 6 are shown in FIG. 8. The scheduling cells include Cell 1, Cell 3, and Cell 5, the sub-carrier spaces of Cell 1 and Cell 3 are 15 kHz, the quantity of scheduled cells corresponding to Cell 1 is 2, and the quantity of scheduled cells corresponding to Cell 3 is 2, so the data of the scheduled cells corresponding to scheduling cells corresponding to 15 kHz is 4. The sub-carrier space of Cell 5 is 30 kHz, and the quantity of scheduled cells corresponding to Cell 3 is 2, so the quantity of scheduled cells corresponding to 30 kHz is 2. According to the methods of the present application, if the function that one DCI schedules data channels of a plurality of cells is supported, the plurality of cells may be: a subset of {Cell 1, Cell 2, Cell 3, Cell 4}, or a subset of {Cell 5, Cell 6}, in other words, scheduling of cell combinations such as Cell 1+Cell 6, or Cell 1+Cell 5, through one DCI is not supported.

In a multi-carrier system, the division of PDCCH detection capability maximizes the reuse of the existing mechanism, and has good backward compatibility. The specific reason is that the quantity of scheduled cells corresponding to scheduling cells with the same sub-carrier space affects M_{PDCCH}^{total,slot,μ} and C_{PDCCH}^{total,slot,μ}, and if the sub-carrier spaces of scheduled cells corresponding to the M cells are the same, the calculation of PDCCH detection capability of the terminal on all scheduled cells with the sub-carrier space u is not affected by the function of “one DCI schedules a plurality of scheduled cells”. In the above view, if the M cells are a subset of {Cell 1, Cell 2, Cell 3, Cell 4} or a subset of {Cell 5, Cell 6}, whether the quantity of scheduled cells corresponding to the scheduling cells with a sub-carrier space of 15 kHz (i.e., Cell 1 and Cell 3) is the same as the quantity of scheduled cells corresponding to the scheduling cells with a sub-carrier space of 15 kHz (i.e., Cell 1 and Cell 3) in the case of “one CDI schedules a channel of a scheduled cell” or is 4 (Cell 1 to Cell 4), and if the M cells are Cell 1+Cell 5, whether the quantity of scheduled cells corresponding to the scheduling cells (i.e., Cell 1 and Cell 3) with a sub-carrier space of 15 kHz is 4 (i.e., Cell 1 to Cell 4), 5 (Cell 1 to Cell 5), or other values need to be discussed and require complicated design mechanism. Therefore, by limiting the numerologies of the scheduled carriers corresponding to the M cells to be the same may simplify the design of PDCCH detection capability division.

III. The sub-carrier spaces or numerologies of scheduling cells corresponding to the M cells may be the same or different. When dividing the total capability of a plurality of carriers, an adjustment coefficient is introduced. The adjustment coefficient is used for adjusting the counting result (such as multiplying, dividing, adding, or subtracting the scheduling coefficient) when counting the scheduled cells according to numerologies of scheduling cells. The adjustment coefficient may be pre-defined in a protocol or configured via higher layer signaling. In particular, the adjustment coefficient may be pre-defined/configure per-(numerology of) scheduling cell. The configuration of an adjustment system may also be extended to configure only one reference adjustment coefficient γ, and the counting of scheduled cells may be added, subtracted, multiplied or divided by γ multipled by n when the scheduling carrier numerologies are different. n may be configured, or determined according to configured combinations of scheduled cells. Further, the adjustment coefficient is introduced only when the numerologies of scheduling cells corresponding to the M cells are different.

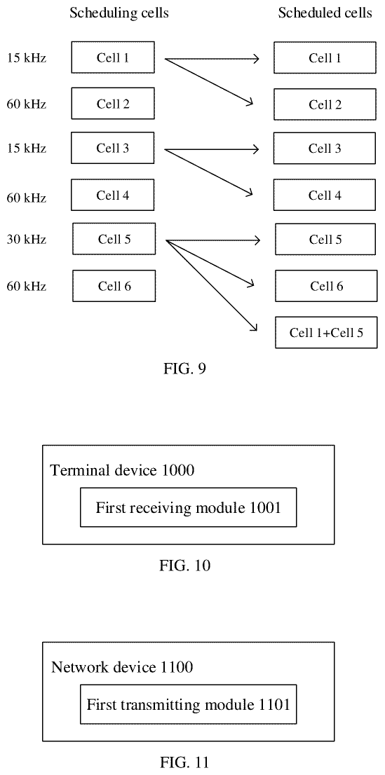

In one example, the network side configures Cell 1 to Cell 6 for the terminal, and the sub-carrier spacs/numerologies of Cell 1 to Cell 6 and scheduling relationship between Cell 1 to Cell 6 are shown in FIG. 8. On the basis of FIG. 8, as shown in FIG. 9, a scheduled cell combination Cell 1+Cell 5 is increased, the network side configures the scheduled cell combination Cell 1+Cell 5 is scheduled by Cell 5, and the maximum quantity of carriers monitored by PDCCH that is reported by the terminal is 2.

In the case that the terminal device does not support that one DCI schedules a plurality of carriers:
for each scheduled carrier, the PDCCH candidates to be detected on the scheduled carrier by the terminal device does not exceed min(M_{PDCCH}^{max,slot,μ}, M_{PDCCH}^{total,slot,μ}), where the values of M_{PDCCH}^{max,slot,μ} is shown in Table 1. The way of calculating M_{PDCCH}^{total,slot,μ} is as follows.

In the six carriers, the quantity of scheduled cells corresponding to the scheduling cells (i.e., Cell 1, Cell 3) with a SCS of 15 kHz is 4 (i.e., Cell 1 to Cell 4), and the quantity of scheduled cells corresponding to the scheduling cell (i.e., Cell 5) with a SCS of 30 kHz is 2 (Cell 5 to Cell 5), so M_{PDCCH}^{total,slot,15 kHz} and M_{PDCCH}^{total,slot,30 kHz} are:

$${M}_{PDCCH}^{total , slot , 15 kHz} = 2 \cdot {M}_{PDCCH}^{m ax , slot , 15 kHz} \cdot 4 / 6 ,$$

$${M}_{PDCCH}^{total , slot , 30 kHz} = 2 \cdot {M}_{PDCCH}^{ma x , slot , 30 kHz} \cdot 2 / 6.$$

In the case where that one DCI schedules a plurality of cells is supported:
for each scheduled cell, the PDCCH candidate for blind detection of the terminal does not exceed min(M_{PDCCH}^{max,slot,μ}, M_{PDCCH}^{total,slot,μ}), where the values of M_{PDCCH}^{max,slot,μ} is shown in Table 1. The way of calculating M_{PDCCH}^{total,slot,μ} is as follows.

Since the network side configures Cell 1+Cell 5 to be scheduled by Cell 5, it is equivalent that a part of the data from Cell 1 will be scheduled by Cell 5 (when there is no one-schedule-more, that is, when a scheduling cell schedules a scheduled cell group, all the data of Cell 1 will be scheduled by Cell 1). Therefore, in the 6 cells, the quantity of scheduled cells corresponding to scheduling cells (Cell 1, Cell 3) with a SCS of 15 kHz should be reduced from 4, and the quantity of scheduled cells corresponding to t scheduling cells (Cell 5) with a SCS of 30 kHz should be increased from 2.

Assuming that numerologies of scheduling cells indicates 15 kHz and 30 kHz, respectively and the corresponding adjustment coefficients are α and β, then M_{PDCCH}^{total,slot,15 kHz} and M_{PDCCH}^{total,slot,30 kHz} are:

$${M}_{PDCCH}^{total , slot , 15 kHz} = 2 \cdot {M}_{PDCCH}^{m ax , slot , 15 kHz} \cdot ( 4 + α ) / 6 ,$$

$${M}_{PDCCH}^{total , slot , 30 kHz} = 2 \cdot {M}_{PDCCH}^{ma x , slot , 30 kHz} \cdot ( 2 + β ) / 6.$$

In another example, β=−α is more appropriate.

In the above, symbol “+” is just for illustration, symbols “+”, “−”, “x”, and “÷” are all applicable.

Here, by referring to the scheduling cells corresponding to the scheduled cells in the scheduled cell group, the following technical effects may be achieved:
1) There is no limit to the scheduling carriers of the M cells, and the configuration/scheduling flexibility is the highest;
2) The introduction of adjustment coefficients ensures that PDCCH detection capabilities are allocated according to the data transmission requirements of different scheduled cells;
3) Compared with configuring adjustment coefficients per scheduled cell, the configuration of per scheduling cell or per scheduling cell sub-carrier space may save signaling overhead and is simpler.

It should be noted that in the wireless communication method provided by the embodiment of the present application, the concepts of “cell” and “carrier” are the same and can be replaced with each other.

The preferred implementations of the present application have been described above in detail with reference to the accompanying drawings. However, the present application is not limited to the specific details in the foregoing implementations. Various simple modifications may be made to the technical solutions of the present application within the technical concept of the present application. These simple variants all fall within the protection scope of the present application. For example, the various specific technical features described in the foregoing specific implementations may be combined with each other in any suitable manner without conflict. In order to avoid unnecessary repetition, the various possible combinations will not be described in the present application. As another example, the various implementations of the present application may be arbitrarily combined, which should also be regarded as the contents disclosed in the present application as long as they do not violate the concept of the present application. As still another example, under the premise of no conflict, the various embodiments and/or the technical features in the various embodiments described in the present application may be arbitrarily combined with the prior art, and the technical solution obtained by combination should also fall within the protection scope of the present application.

It should be understood that in each embodiment of the present application, the sequence quantitys of the above-mentioned processes do not mean the order of execution, and the order of execution of each process should be determined by its functions and internal logic, and should not constitute any limitation on the implementing process of the embodiment of the present application. Furthermore, in the embodiments of the present application, terms such as “downlink”, “uplink” and “sidelink” are intended to indicate transmission directions of signals or data. The term “downlink” is intended to indicate that a transmission direction of signals or data is a first direction of sending signals or data from a station to UE in a cell, the term “uplink” is intended to indicate that a transmission direction of signals or data is a second direction of sending signals or data from UE in a cell to a station, and the term “sidelink” is intended to indicate that a transmission direction of signals or data is a third direction of sending signals or data from UE 1 to UE 2. For example, “downlink signal” indicates that a transmission direction of the signal is the first direction. In addition, in the embodiments of the present application, the term “and/or” refers to an association relationship describing associated objects, which indicates that there may be three kinds of relationships. For example, “A and/or B” may indicate three cases that: A exists alone, both A and B exist, and B exists alone. The character “/” herein generally indicates that associated objects before and after the character “/” have an “or” relationship.

FIG. 10 is a schematic block diagram of a terminal device provided by the embodiments of the present application, which is applied to a terminal device. As shown in FIG. 10, the terminal device 1000 includes:
a first receiving module 1001 configured to receive first downlink control information (DCI) transmitted by a network device, where the first DCI is used for scheduling channels of at least two first cells.

In some embodiments, in a first scheduling relationship, scheduling cells corresponding to all of the at least two first cells are the same.

In some embodiments, the terminal device does not expect that scheduling cells corresponding to all of the at least two first cells are not the same scheduling cell.

In some embodiments, the terminal device does not report first capability indication information to the network device.

In some embodiments, in a first scheduling relationship, the scheduling cells corresponding to all of the at least two first cells are the same or not the same scheduling cell.

In some embodiments, the device 1100 further includes a first report unit configured to report first capability indication information to the network device.

In some embodiments, the first capability indication information is used to indicate that the terminal device supports at least one of:
that one DCI schedules channels of at least two scheduled cells, and scheduling cells corresponding to all of the at least two scheduled cells are not the same scheduling cell; or that one scheduled cell is scheduled by at least two scheduling cells.

In some embodiments, in a first scheduling relationship, first parameters corresponding to scheduling cells corresponding to all of the at least two first cells are the same, the first parameters are sub-carrier spaces, or the first parameters are used to define sub-carrier spaces and/or cyclic prefixes.

In some embodiments, the terminal device does not expect that first parameters corresponding to scheduling cells corresponding to all of the at least two first cells are not the same first parameter.

In some embodiments, the terminal device does not report second capability indication information to the network device.

In some embodiments, in a first scheduling relationship, first parameters corresponding to scheduling cells corresponding to all of the at least two first cells are the same or not the same first parameter, the first parameters are sub-carrier spaces, or the first parameters are used to define sub-carrier spaces and/or cyclic prefixes.

In some embodiments, the terminal device 1000 further includes a second report unit configured to report second capability indication information to the network device.

In some embodiments, the second capability indication information indicates that the terminal device supports at least one of:
that one DCI schedules channels of at least two scheduled cells, and first parameters corresponding to scheduling cells corresponding to all of the at least two scheduled cells are not the same first parameter; or
that one scheduled cell is schuduled by at least two scheduling cells, first parameters corresponding to the at least two scheduling cells being not the same first parameter.

In some embodiments, the first scheduling relationship is configured by the network device via higher layer signaling.

In some embodiments, in the first scheduling relationship, one scheduled cell corresponds to one scheduling cell.

In some embodiments, the terminal device 1000 further includes a determination module that is configured to determine, based on an adjustment coefficient, a maximum value of a quantity of candidate physical downlink control channels (PDCCHs) or non-overlapped control channel elements (CCEs) to be monitored on an active bandwidth part (BWP) of a second cell or a second cell group. The second cell group includes at least two second cells, first parameters corresponding to the at least two second cells are the same, and the second cell is any scheduling cell.

In some embodiments, the adjustment coefficient corresponds to the second cell or the second cell group, or the adjustment coefficient corresponds to a first parameter corresponding to the second cell or the second cell group; and the first parameter is a sub-carrier space, or the first parameter is used to define a sub-carrier space and/or a cyclic prefix.

In some embodiments, the adjustment coefficient is used for adjustment of a first quantity, the first quantity is a quantity of scheduled cells corresponding to the second cell or the second cell group, or the first quantity is a quantity of scheduled cells corresponding to a second parameter, and the second parameter is a first parameter corresponding to the second cell or the second cell group.

In some embodiments, the adjustment coefficient is used to adjust the first quantity to a second quantity, the second quantity is greater than or equal to the first quantity, and the second cell or the second cell group includes a third cell used for carrying the first DCI.

In some embodiments, the adjustment coefficient is used to adjust the first quantity to a third quantity, the third quantity is less than or equal to the first quantity, the second cell or the second cell group does not include a third cell used for carrying the first DCI.

In some embodiments, a way of determining the adjustment coefficient includes:
pre-defining in a protocol; or,
configuring by the network device.

In some embodiments, first parameters corresponding to scheduling cells corresponding to all of the at least two first cells are not the same first parameter, the first parameters are sub-carrier spaces, or the first parameters are used to define sub-carrier spaces and/or cyclic prefixes.

FIG. 11 is a schematic block diagram of a network device provided by the embodiments of the present application. As shown in FIG. 11, the network device 1100 includes:
a first transmitting module 1101 configured to transmit first downlink control information (DCI) to a terminal device, where the first DCI is used for scheduling channels of at least two first cells.

In some embodiments, in a first scheduling relationship, scheduling cells corresponding to all of the at least two first cells are the same.

In some embodiments, the network device does not receive first capability indication information reported by the terminal device.

In some embodiments, in a first scheduling relationship, scheduling cells corresponding to all of the at least two first cells are the same or not the same scheduling cell.

In some embodiments, the network device 1100 further includes a second receiving module configured to receive first capability indication information reported by the terminal device.

In some embodiments, the first capability indication information is used to indicate that the terminal device supports at least one of:
that one DCI schedules channels of at least two scheduled cells, and scheduling cells corresponding to all of the at least two scheduled cells are not the same scheduling cell; or
that one scheduled cell is scheduled by at least two scheduling cells.

In some embodiments, in a first scheduling relationship, first parameters corresponding to scheduling cells corresponding to all of the at least two first cells are the same, the first parameters are sub-carrier spaces, or the first parameters are used to define sub-carrier spaces and/or cyclic prefixes.

In some embodiments, the network device does not expect that first parameters corresponding to scheduling cells corresponding to all of the at least two first cells are not the same first parameter.

In some embodiments, the network device does not receive second capability indication information reported by the terminal device.

In some embodiments, in a first scheduling relationship, first parameters corresponding to scheduling cells corresponding to all of the at least two first cells are the same or not the same first parameter, the first parameters are sub-carrier spaces, or the first parameters are used to define sub-carrier spaces and/or cyclic prefixes.

In some embodiments, the network device 1100 further includes a third receiving module configured to receive second capability indication information reported by the terminal device.

In some embodiments, the second capability indication information indicates that the terminal device supports at least one of:
that one DCI schedules channels of at least two scheduled cells, and first parameters corresponding to scheduling cells corresponding to all of the at least two scheduled cells are not the same first parameter; or
that one scheduled cell is scheduled by at least two scheduling cells, first parameters corresponding to the at least two scheduling cells being not the same first parameter.

In some embodiments, the first scheduling relationship is configured by the network device via higher layer signaling.

In some embodiments, in the first scheduling relationship, one scheduled cell corresponds to one scheduling cell.

In some embodiments, the network device 1100 further includes a second transmitting module that is configured to configure an adjustment coefficient to the terminal device, where the adjustment coefficient is used to determine a maximum value of a quantity of candidate physical downlink control channels (PDCCHs) or non-overlapped control channel elements (CCEs) to be monitored by the terminal device on an active bandwidth part (BWP) of a second cell or a second cell group, the second cell group includes at least two second cells, first parameters corresponding to the at least two second cells are the same, and the second cell is any scheduling cell.

In some embodiments, the adjustment coefficient corresponds to the second cell or the second cell group, or the adjustment coefficient corresponds to a first parameter corresponding to the second cell or the second cell group; and the first parameter is a sub-carrier space, or the first parameter is used to define a sub-carrier space and/or a cyclic prefix.

In some embodiments, the adjustment coefficient is used for adjustment of a first quantity, the first quantity is a quantity of scheduled cells corresponding to the second cell or the second cell group, or the first quantity is a quantity of scheduled cells corresponding to a second parameter, and the second parameter is a first parameter corresponding to the second cell or the second cell group.

In some embodiments, the adjustment coefficient is used to adjust the first quantity to a second quantity, the second quantity is greater than or equal to the first quantity, and the second cell or the second cell group includes a third cell used for carrying the first DCI.

In some embodiments, the adjustment coefficient is used to adjust the first quantity to a third quantity, the third quantity is less than or equal to the first quantity, the second cell or the second cell group does not include a third cell used for carrying the first DCI.

In some embodiments, first parameters corresponding to scheduling cells corresponding to all of the at least two first cells are not the same first parameter, the first parameters are sub-carrier spaces, or the first parameters are used to define sub-carrier spaces and/or cyclic prefixes.

Those skilled in the art should understand that the above relevant descriptions of the terminal device or the network device in the embodiments of the present application can be understood by referring to the relevant descriptions about the wireless communication method in the embodiments of the present application.

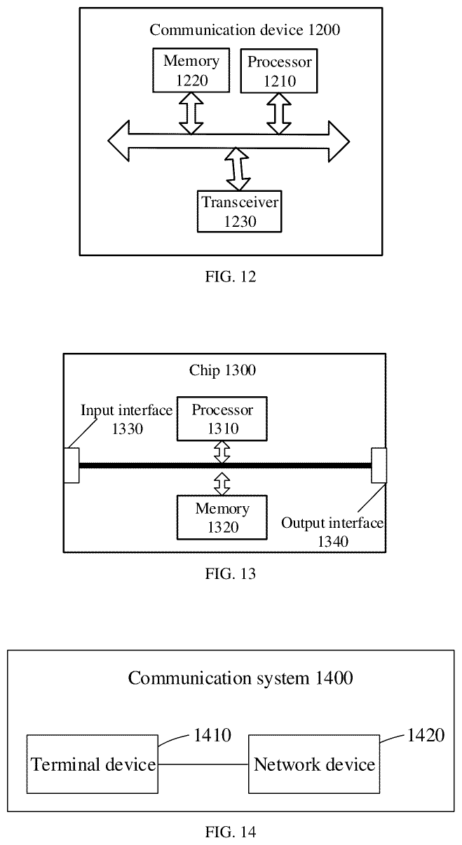

FIG. 12 is a schematic block diagram of a communication device 1200 provided by the embodiments of the present application. The communication device may be a terminal device or a network device. The communication device 1200 shown in FIG. 12 includes a processor 1210, which may call and run a computer program from a memory to implement the methods in the embodiments of the present application.

Optionally, as shown in FIG. 12, the communication device 1200 further includes a memory 1220. The processor 1210 may call and run a computer program from the memory 1220 to implement the methods in the embodiments of the present application.

The memory 1220 may be a separate device independent of the processor 1210, or may be integrated in the processor 1210.

Optionally, as shown in FIG. 12, the communication device 1200 may further include a transceiver 1230, and the processor 1210 may control the transceiver 1230 to communicate with another device. Specifically, the transceiver 1230 may send information or data to another device or receive information or data transmitted by another device.

The transceiver 1230 may include a transmitter and a receiver. The transceiver 1230 may also further include antenna(s), and the quantity of antennas may be one or more.

Optionally, the communication device 1200 may specifically be the network device in the embodiments of the present application, and the communication device 1200 may implement corresponding processes implemented by the network device in various methods in the embodiments of the present application, which will not be repeated here for brevity.

Optionally, the communication device 1200 may specifically be the mobile terminal/terminal device in the embodiments of the present application, and the communication device 1200 may implement corresponding processes implemented by the mobile terminal/terminal device in various methods in the embodiments of the present application, which will not be repeated here for brevity.

FIG. 13 is a schematic block diagram of a chip according to embodiments of the present application. The chip 1300 shown in FIG. 13 includes a processor 1310, which may call and run a computer program from a memory to implement the methods in the embodiments of the present application.

Optionally, as shown in FIG. 13, the chip 1300 may further include a memory 1320. The processor 1310 may call and run a computer program from the memory 1320 to implement the methods in the embodiments of the present application

The memory 1320 may be a separate device independent of the processor 1310, or may be integrated in the processor 1310.

Optionally, the chip 1300 may further include an input interface 1330. The processor 1310 may control the input interface 1330 to communicate with another device or chip, specifically, to obtain information or data transmitted by another device or chip.

Optionally, the chip 1300 may further include an output interface 1340. The processor 1310 may control the output interface 1340 to communicate with another device or chip, specifically, to output information or data to another device or chip.

Optionally, the chip may be applied to the network device in the embodiments of the present application, and the chip may implement corresponding processes implemented by the network device in various methods in the embodiments of the present application, which will not be repeated here for brevity.

Optionally, the chip may be applied to the mobile terminal/terminal device in the embodiments of the present application, and the chip may implement corresponding processes implemented by the mobile terminal/terminal device in various methods in the embodiments of the present application, which will not be repeated here for brevity.

It should be understood that the chip mentioned in the embodiments of the present application may also be referred to as a system-level chip, a system chip, a chip system, or a system on chip.

FIG. 14 is a schematic block diagram of a communication system 1400 provided by the embodiments of the present application. As shown in FIG. 14, the communication system 1400 includes a terminal device 1410 and a network device 1420.

The terminal device 1410 may be configured to implement the corresponding functions implemented by the terminal device in the above-mentioned methods, and the network device 1420 may be configured to implement the corresponding functions implemented by the network device in the above-mentioned methods, which will not be repeated here for brevity.

It should be understood that the processor in the embodiments of the present application may be an integrated circuit chip with a capability for processing signals. In an implementation process, various steps of the method embodiments described above may be completed through an integrated logic circuit of hardware in a processor or instructions in a form of software. The processor described above may be a general purpose processor, a digital signal processor (DSP), an application specific integrated circuit (ASIC), a field programmable gate array (FPGA), or another programmable logic device, a discrete gate or transistor logic device, or a discrete hardware component. The processor may implement various methods, steps, and logic block diagrams disclosed in the embodiments of the present application. The general purpose processor may be a microprocessor or the processor may be any conventional processor. The steps of the method disclosed with reference to the embodiment of the present application may be directly implemented by a hardware decoding processor, or may be executed and completed by a combination of hardware and software modules in a decoding processor. The software modules may be located in a storage medium commonly used in the art, such as a random access memory, a flash memory, a read-only memory, a programmable read-only memory or an electrically erasable programmable memory, or a register. The storage medium is located in a memory, and the processor reads information in the memory and completes the steps of the above methods in combination with hardware of the processor.

It will be appreciated that the memory in the embodiments of the present application may be a volatile or non-volatile memory, or may include both volatile and non-volatile memories. The non-volatile memory may be a read-only memory (ROM), a programmable ROM (PROM), an erasable PROM (EPROM), electrically EPROM (EEPROM), or a flash memory. The volatile memory may be a random access memory (RAM) which serves as an external cache. As an example, but not as a limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the memories of the systems and methods described herein are intended to include, but are not limited to, these and any other suitable types of memories.

It should be understood that the above memories are described as examples rather than limitations. For example, the memory in the embodiments of the present application may be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), or a direct rambus RAM (DR RAM). That is to say, the memories in the embodiments of the present application are intended to include, but are not limited to, these and any other suitable types of memories.

The embodiments of the present application further provide a non-transitory computer-readable storage medium configured to store a computer program.

Optionally, the computer-readable storage medium may be applied to the network device in the embodiments of the present application, and the computer program causes a computer to perform corresponding processes implemented by the network device in various methods in the embodiments of the present application, which will not be repeated here for brevity.

Optionally, the non-transitory computer-readable storage medium may be applied to the mobile terminal/terminal device of the embodiments of the present application, and the computer program causes a computer to perform corresponding processes implemented by the mobile terminal/terminal device in various methods in the embodiments of the present application, which will not be repeated here for brevity.

The embodiments of the present application further provide a computer program product including computer program instructions.

Optionally, the computer program product may be applied to the network device in the embodiments of the present application, and the computer program instructions cause a computer to perform corresponding processes implemented by the network device in various methods in the embodiments of the present application, which will not be repeated here for brevity.

Optionally, the computer program product may be applied to the mobile terminal/terminal device in the embodiments of the present application, and the computer program instructions cause a computer to perform corresponding processes implemented by the mobile terminal/terminal device in various methods in the embodiments of the present application, which will not be repeated here for brevity.

The embodiments of the present application further provide a computer program.

Optionally, the computer program may be applied to the network device in the embodiments of the present application. The computer program, when executed by a computer, causes the computer to perform corresponding processes implemented by the network device in various methods in the embodiments of the present application, which will not be repeated here for brevity.

Optionally, the computer program may be applied to the mobile terminal/terminal device in the embodiments of the present application. The computer program, when executed by a computer, causes the computer to perform corresponding processes implemented by the mobile terminal/terminal device in various methods in the embodiments of the present application, which will not be repeated here for brevity.

Those of ordinary skills in the art will recognize that units and algorithm steps of various examples described in connection with the embodiments disclosed herein may be implemented in electronic hardware, or a combination of computer software and electronic hardware. Whether these functions are implemented in a form of hardware or software depends on a specific application and a design constraint of a technical solution. Those skilled in the art may use different methods to implement the described functions for each specific application, but such implementation should not be considered to be beyond the scope of the present application.

Those skilled in the art may clearly understand that for convenience and conciseness of description, specific working processes of the systems, devices/apparatuses, and units described above may refer to corresponding processes in the aforementioned method embodiments, and details will not be repeated here.

In several embodiments according to the present application, it should be understood that the disclosed systems, devices/apparatuses, and methods may be implemented in other ways. For example, the device/apparatus embodiments described above are only illustrative, for example, the division of the units is only a logical function division, and there may be other division manners in actual implementation. For example, multiple units or components may be combined or integrated into another system, or some features may be ignored or not executed. In addition, coupling or direct coupling or communication connection shown or discussed between each other, which may be indirect coupling or communication connection between the devices or units via some interfaces, may be electrical, mechanical, or in other forms.

The units described as separate components may be or may be not physically separated, and the component shown as a unit may be or may be not a physical unit, i.e., it may be located in one place or may be distributed on multiple network units. Some or all of units may be selected according to actual needs to achieve purposes of technical solutions of the embodiments.

In addition, various function units in various embodiments of the present application may be integrated in one processing unit, or various units may be physically present separately, or two or more units may be integrated in one unit.

The functions, if implemented in a form of software function units and sold or used as an independent product, may be stored in a non-transitory computer-readable storage medium. For such understanding, the technical solutions of the present application, in essence, or the part which contributes to the prior art, or part of the technical solutions, may be embodied in the form of a software product, in which the computer software product is stored in one non-transitory storage medium including a quantity of instructions for causing one computer device (which may be a personal computer, a server, or a network device) to perform all or some of the steps of the methods according to various embodiments of the present application. The aforementioned storage media includes various media capable of storing program codes, such as a U disk, a mobile hard disk, a read-only memory (ROM), a random access memory (RAM), a magnetic disk, an optical disk, and the like.

The foregoing are merely specific embodiments of the present application, but the protection scope of the present application is not limited thereto. Any person skilled in the art may readily conceive variations or substitutions within the technical scope disclosed by the present application, which should be included within the protection scope of the present application. Therefore, the protection scope of the present application shall be subject to the protection scope of the claims.

What is claimed is:

1. A wireless communication method, the method comprising:
receiving, by a terminal device, first downlink control information (DCI) transmitted by a network device, the first DCI being used for scheduling channels of at least two first cells.

2. The method according to claim 1, wherein in a first scheduling relationship, scheduling cells corresponding to all of the at least two first cells are same.

3. The method according to claim 2, wherein the terminal device does not expect that scheduling cells corresponding to all of the at least two first cells are not a same scheduling cell.

4. The method according to claim 1, wherein in a first scheduling relationship, first parameters corresponding to scheduling cells corresponding to all of the at least two first cells are same, the first parameters are sub-carrier spaces, or the first parameters are used to define sub-carrier spaces and/or cyclic prefixes.

5. The method according to claim 4, wherein the terminal device does not expect that first parameters corresponding to scheduling cells corresponding to all of the at least two first cells are not a same first parameter.

6. The method according to claim 2, wherein the first scheduling relationship is configured by the network device via higher layer signaling.

7. The method according to claim 2, wherein in the first scheduling relationship, one scheduled cell corresponds to one scheduling cell.

8. A wireless communication method, the method comprising:
transmitting, by a network device, first downlink control information (DCI) for scheduling channels of at least two first cells to a terminal device.

9. The method according to claim 8, wherein in a first scheduling relationship, scheduling cells corresponding to all of the at least two first cells are same.

10. The method according to claim 8, wherein in a first scheduling relationship, first parameters corresponding to scheduling cells corresponding to all of the at least two first cells are same, the first parameters are sub-carrier spaces, or the first parameters are used to define sub-carrier spaces and/or cyclic prefixes.

11. The method according to claim 10, wherein the network device does not expect that first parameters corresponding to scheduling cells corresponding to all of the at least two first cells are not a same first parameter.

12. The method according to claim 9, wherein the first scheduling relationship is configured by the network device via higher layer signaling.

13. The method according to claim 9, wherein in the first scheduling relationship, one scheduled cell corresponds to one scheduling cell.

14. A terminal device, comprising:
a transceiver;
a memory, configured to store a computer program; and
a processor, configured to call and run the computer program stored in the memory to control the transceiver to perform:
receiving first downlink control information (DCI) transmitted by a network device, the first DCI being used for scheduling channels of at least two first cells.

15. The terminal device according to claim 14, wherein in a first scheduling relationship, scheduling cells corresponding to all of the at least two first cells are same.

16. The terminal device according to claim 15, wherein the terminal device does not expect that scheduling cells corresponding to all of the at least two first cells are not a same scheduling cell.

17. The terminal device according to claim 14, wherein in a first scheduling relationship, first parameters corresponding to scheduling cells corresponding to all of the at least two first cells are same, the first parameters are sub-carrier spaces, or the first parameters are used to define sub-carrier spaces and/or cyclic prefixes.

18. The terminal device according to claim 17, wherein the terminal device does not expect that first parameters corresponding to scheduling cells corresponding to all of the at least two first cells are not a same first parameter.

19. The terminal device according to claim 15, wherein the first scheduling relationship is configured by the network device via higher layer signaling.

20. The terminal device according to claim 15, wherein in the first scheduling relationship, one scheduled cell corresponds to one scheduling cell.
